(19) United States
(12) Patent Application Publication
(10) Pub. No.: US 2019/0346177 A1
(43) Pub. Date: Nov. 14, 2019

(54) CONCENTRATED SOLAR RECEIVER AND REACTOR SYSTEMS COMPRISING HEAT TRANSFER FLUID

(71) Applicant: The University of Adelaide, Adelaide (AU)

(72) Inventors: Mehdi Jafarian, Klemzig (AU); Maziar Arjomandi, Beaumont (AU); Mohammad Reza Abdollahi, Lemzig (AU); Graham Jerrold Nathan, Ironbank (AU)

(21) Appl. No.: 16/479,441

(22) PCT Filed: Jan. 19, 2018
(86) PCT No.: PCT/AU2018/050034

§ 371 Date: Jul. 19, 2019

(30) Foreign Application Priority Data
Jan. 19, 2017 (AU) 2017900167
Feb. 21, 2017 (AU) 2017900564

(51) Int. Cl. F24S 10/20; F24S 20/00; F23C 9/00; F28D 20/00; F24S 60/00

(52) U.S. Cl. CPC F24S 10/20; F24S 20/00; F24S 60/00; F28D 20/00; F23C 9/00

(57) ABSTRACT

Apparatus operable using concentrated solar radiation, the apparatus comprising a body having a cavity adapted to receive concentrated solar radiation, a heat energy absorber associated with the cavity to receive heat from concentrated solar radiation within the cavity, a chamber containing a body of matter, the chamber being in heat exchange relation with the heat energy absorber to receive heat therefrom for heating the body of matter, and an inlet means for introducing fluid into the chamber for contacting the contained body of matter. Also, a reactor system for contacting a reactant liquid with two gaseous reactants, the reactor system comprising two reactors interconnected for circulation of a reactant liquid therebetween, whereby the circulating reactant liquid is enabled to react with a gaseous reactant introduced into one reactor and to also react with a gaseous reactant introduced into the other reactor.

### FIELD OF THE INVENTION

The present invention relates to apparatus operable using concentrated solar radiation, as well as a related method. This invention also relates to apparatus for treating a fluid using thermal energy derived from concentrated solar radiation, as well as a related method. This invention further relates to a reactor system for contacting a reactant liquid with gaseous reactant(s). The invention also relates to a method of contacting a reactant liquid with one or more gaseous reactants.

The invention has been developed primarily for use in methods and systems for use in power generation, energy storage or chemical processing. However, it will be appreciated that the invention is not limited to this particular field of use.

Embodiment of the invention have been devised particularly, although not exclusively, for heating a fluid, the method comprising heating a body of heat transfer liquid, introducing fluid to be heated into the heated body of heat transfer liquid, separating the fluid from the body of heat transfer liquid as a heated fluid, and collecting the separated fluid. Although the heated fluid can also be a liquid or a multiphase fluid comprising solid, liquid and gaseous phases.

Embodiments of the invention also relate to a solar thermal liquid chemical looping or reduction/oxidation ‘redox’ system or any chemical looping systems for which the enthalpy of reduction (endothermic reaction(s)) is provided by concentrated solar thermal energy that is introduced to a reduction reactor or any section of the process. However, applications are not restricted to redox processes. The heat source is not also restricted to solar thermal energy.

Embodiments of the invention have been devised particularly, although not necessarily solely, for performing liquid chemical looping combustion (LCLC) or for liquid chemical looping gasification (LCLG), although other applications are contemplated where there is a requirement for circulation of a reactant liquid between two reactors to enable the liquid to react with two gaseous reactants. The two gaseous reactants would typically be different gaseous reactants (as for example is the case with LCLC and LCLG), although not necessarily so in all application of the invention.

Embodiments of the invention have been devised particularly, although not necessarily solely to augment the rate of heat and mass transfer in multiphase systems.

The apparatus may comprise a solar receiver for capturing heat energy from a solar source or a hybrid receiver-combustor for capturing heat energy from a solar source and a fuel source. In the latter case, the hybrid receiver-combustor is adapted to capture heat energy from a solar source and accommodate combustion to generate heat from a fuel source.

### BACKGROUND OF THE INVENTION

Any discussion of the background art throughout the specification should in no way be considered as an admission that such background art is prior art, nor that such background art is widely known or forms part of the common general knowledge in the field in Australia or worldwide.

All references, including any patents or patent applications, cited in this specification are hereby incorporated by reference. No admission is made that any reference constitutes prior art. The discussion of the references states what their authors assert, and the applicants reserve the right to challenge the accuracy and pertinence of the cited documents. It will be clearly understood that, although a number of prior art publications are referred to herein, this reference does not constitute an admission that any of these documents forms part of the common general knowledge in the art, in Australia or in any other country.

The sun, as the world's primary source of energy with a surface temperature of about 5800 K and a solar radiosity of 63 MW/m², is an unlimited source of radiation that can be concentrated to provide high temperature heat. Harnessing it has little impacts on the ecology. However, solar energy is inherently intermittent, distributed unequally over the earth and highly diluted owing to the sun-to-earth geometrical constraint, to the extent that terrestrial solar irradiance at maximum is about 1 kW/m². Optical concentrator devices enable high solar radiative fluxes with relatively low thermal losses. They use large reflective surfaces to collect and concentrate the incident solar radiation into a solar receiver, in which the high temperature heat can be utilized. However, efficient harnessing of the heat within the solar receiver is technically challenging owing both to the material constraints and heat transfer limitations associated with the material used in the state-of-the-art. Hence new technologies are required to address these challenges.

The unique thermo-chemical and thermo-physical properties of liquid metal/metal oxides make them an attractive option for being used as a heat transfer fluid (HTF) where cooling of surfaces exposed to extremely high heat flux is needed. These attractive thermo-physical and physical properties are:
(a) possibility for producing a homogenous or nonhomogeneous molten phase with a variable oxygen content, depending mainly on the state of oxidation;
(b) possibility for high rates of heat transfer as a result of their high thermal conductivity and low Prandtl numbers. This leads to high heat transfer coefficients, which enables efficient heat exchange with low temperature difference, specifically where large quantities of energy must be transferred from a relatively small surface. Advantageously, this also enables more compact heat exchanger design;
(c) low vapour pressure and high boiling temperatures. The metal/metal oxides remain in the liquid state at higher temperatures than conventional fluids like water and organic coolants.

The solar to electrical efficiency of concentrated solar power (CSP) plants can be improved significantly through increasing the temperature of the inlet hot gas to the gas turbines. An example of such a CSP power plant is a hybrid solar gas turbine, where the concentrated solar thermal energy and the combustion of the fuel are used to increase the temperature of the pressurised air before introduction to the gas turbine. In this system, typically the concentrated solar thermal energy is first used to preheat the pressurised air coming from the compressor at a pressure of about 3-35 bar, within a pressurised solar receiver, and then the heated air goes through an after-burner to be further heated to a temperature of around 1250° C. The after-burner is also used to compensate for fluctuating solar input and to keep the power cycle working when solar thermal heat is not available. In such a hybrid solar gas turbine system, the solar share increases with an increase of the temperature of the output pressurised air from the solar receiver, while the efficiency of the solar receiver decreases with it, which is mainly due to the increase of the re-radiation heat losses.

Various configurations of pressurised solar receiver have been proposed based on direct or indirect heating concepts. In direct heating configurations, concentrated solar thermal radiation is either absorbed directly by the high-pressure gas or by a surface which is exposed to it, while in indirect heating concept the working fluid is not directly exposed to either the solar radiation or the surface heated by it. In this method, concentrated solar thermal energy is first absorbed on a surface and then is transferred through a conductive medium to a second surface on which heat is mainly transferred to the pressurised air by convection. Outlet air temperatures of up to 1300° C. have been achieved using direct heating concepts owing to its high heat transfer rate. However, these solar receivers typically require a transparent window which is vulnerable to high pressure, especially when the window size increases. It has been also demonstrated that the application of a window imposes serious technical construction and operating problems owing to special requirements in optical properties, mechanical strength, high diurnal variable working temperature of the receiver, sealing, cooling and stress-less installation. In indirect-irradiated solar receivers the need for the window is eliminated by using an appropriate heat transfer medium. However, this is achieved at the cost of conduction-limited heat transfer rates through the solar absorber walls, as described above. Consequently, the disadvantages are associated with the restrictions imposed by the material of construction such as resistance to thermal shock, thermal conductivity and inertness to oxidation by air. Recently, a 3 kW high temperature indirect pressurised air solar receiver prototype was developed. This solar receiver comprises an annular reticulated porous ceramic (RPC) fabricated within a cylindrical cavity receiver. Concentrated solar radiation is first absorbed over inner surface of the cylindrical cavity receiver and then the absorbed heat is transferred to the pressurised, air flowing across the RPC. A small-scale prototype of this system achieved a maximum outlet temperature of around 1060° C. at an absolute operating pressure of 5 bar and an average incident solar heat flux of 4360 W/m² yielding a thermal efficiency of 36%. However, the peak thermal efficiency obtained by this system was 77% at an outlet temperature of 553° C. due to the lower re-radiation losses. This novel solar receiver has not been demonstrated in commercial scale and its thermal efficiency is low due to high re-radiation heat losses. More recently, this solar receiver was further improved and tested in a solar tower for up to 47 kW of concentrated solar radiative power input in the absolute pressure range of 2-6 bar. This receiver consists of a cylindrical SiC cavity surrounded by a concentric annular reticulated porous ceramic (RPC) foam contained in a stainless steel pressure vessel, with a secondary concentrator attached to its windowless aperture. Peak outlet air temperatures of around 1200° C. were reached for an average solar concentration ratio of 2500 suns. A thermal efficiency of about 91% was achieved at 700° C. and 4 bar.

The following limitations have been identified in this solar receiver:
(a) The RPC is mainly employed to facilitate the heat dissipation through increasing the surface area exposed to pressurised air. However, the limited thermal conductivity of porous ceramics (SiSiC: 100-32 (Wm−1K−1) in temperature range of 473-1473 K, SSiC: 124-33 (Wm−1K−1) in temperature range of 473-1473 K results in a large temperature gradient between the solar cavity, where the concentrated solar radiation is introduced and absorbed, and the surface exposed to air. This in turn increases both the re-radiation heat losses and the potential for thermal shock, which can decrease the life of the components.
(b) Gas-sealing is a key technical challenge that arises from the use of ceramics, particularly at high temperatures.
(c) A gap is needed between the RPC and the cavity/receiver wall to allow for differential thermal expansion. The larger the temperature difference between hot and cold operation, the larger must be the difference in diameter between the RPC and the cavity of the receiver. This leads to a barrier to heat transfer. The need for the above gap also results in some of the heat transfer fluid bypassing the RPC to flow through the gap instead of through the RPC. This “leakage” leads to the need for a larger device to achieve the same temperature rise, or to an energy loss due to a lower temperature rise.
(d) The constraints imposed by thermal expansion, as described above, limit the size of solar receivers with RPC to relatively small-scale units.

An alternative type of background art is a gas-lift reactor, which has previously been used to react a liquid with a gaseous reactant. Gas-lift reactors evolved from the initial “Pachuca Tank”, which was used in metallurgy industries to leach ores of gold, uranium and other metals, to the new configurations such as internal loop and external loop air-lift reactors used in the biological and chemical industries. The advantages of using gas-lift reactors include efficient mixing, high heat and mass transfer rates, potential to avoid the need for mechanical parts and low energy consumption relative to the traditional stirring tanks and pumps. However, gas-lift reactors are inefficient when used with viscous liquids because a high viscosity results in a high pressure loss and a low velocity of the rising fluids.

A gas-lift reactor is a pneumatically agitated device, characterised by the circulation of a fluid in a defined cyclical pattern. Although various configurations of gas-lift reactors have been proposed, they can be classified into two main categories, namely internal and external gas-lift reactors. A gas-lift reactor, regardless of its configuration, incorporates a riser, a downcomer and gas separators. The gas is injected from the bottom of the riser, through spargers, and mixes with a portion of the surrounding liquid, lowering the density of the mixture relative to the remaining liquid in the riser. The density difference induces a “lift” within the riser, causing the mixture to rise to the top. When the mixture reaches the top, the gas leaves the system causing the remaining liquid, which is denser than the rising mixture, to move towards the side and into the downcomer. The downcomer returns the liquid to the bottom of the riser, where it is mixed with the injected gas again so that the process continues.

The majority of the state-of-the-art in gas-lift reactors react a liquid with a single gaseous reactant in a single reactor.

The unique thermo-chemical and thermo-physical properties of liquid metal/metal oxides makes them an attractive option for use a chemical looping process with consecutive reduction and oxidation (Red-Ox) reactions of an oxygen carrier. These attractive thermo-physical and physical properties comprise:
(a) the capacity to act either as reductive or oxidative reactants, depending on the chemical potential of the oxidant or reductant in the solid and gas phases, and on the operating conditions;
(b) the potential to achieve either a homogenous or an inhomogeneous molten phase with a variable oxygen content, depending on the state of oxidation;
(c) a low vapour pressure and a high boiling temperature (the metal/metal oxides remain in the liquid state at higher temperatures than do conventional fluids like water and organic coolants);
(d) a higher rate of reaction for reduction and oxidation (Red-Ox) in the gas-liquid phases than for the gas-solid phases (this being due both to the elimination of the gas-solid diffusion step, which is necessary gas-solid reactions, and to the high rates of heat transfer, which is necessary to supply the energy needed to activate reactions at high temperature);
(e) possibility for high rate of heat transfer as a result of high thermal conductivity and low Prandtl number.

The term chemical looping is typically used to describe a cyclical process in which a solid material is employed as an oxygen carrier for successive Red-Ox reactions. These can potentially be applied to combust, reform or gasify a fuel or to thermo-chemically split water (H₂O) into H₂ and O₂ or to split carbon dioxide (CO₂) into C and O₂. The solid metal oxide is reduced in one part of the cycle due to the difference in the chemical potential of the oxygen in the solid and gas phases, which can be caused either by an external oxidant such as a fuel or by the lower partial pressure of oxygen in the gas phase than that for equilibrium at the associated temperature. In the second part of the cycle, which closes the loop, the oxygen-depleted material is re-oxidized in an oxygen-rich environment, to allow the cycle to be repeated.

Chemical looping combustion (CLC) is a technology under development that provides inherent capability for CO₂ capture in the combustion of hydrocarbon fuels. Various economic assessments for CO₂ capture have shown that CLC is among the best of the options available for low cost CO₂ capture from combustion. In these systems, a metal oxide is employed as an oxygen carrier (OC) to provide the oxygen for fuel oxidation, while avoiding direct contact between the fuel and air. The OC is typically transported as a solid particle, which comprises both active and inert components, although fixed bed configurations of solid OC media have been also proposed. A CLC system consists of two separate reactors, an air reactor and a fuel reactor. During the CLC operation, the OC particles in the fuel reactor are reduced through oxidation of the fuel and are then transferred to the air reactor, where they are oxidised by the oxygen from the air. The metal oxides so produced are then transferred back to the fuel reactor and the cycle is repeated. The use of the solid OCs limits the operating temperature of the CLC systems to typically around 1000° C., to avoid softening, sintering or other damage. This is significantly lower than both the temperature that can be achieved through combustion of the fuels in conventional combustion systems and the operating temperature of the state-of-the-art in commercially available gas turbines, which is currently around 1300° C., thereby lowering the maximum thermodynamic efficiency of the CLC-based power cycles relative to that which can be achieved with conventional combustion. Furthermore, the life of solid OC particles is limited by changes to the crystalline structure that occurs with cycling, together with agglomeration and erosion, which occurs from transporting the particles and leads to particle attrition, breakage and deactivation. The vulnerability of the particles to breakage leads to serious challenges both to their efficient circulation between the reactors and to the application of the CLC to gas turbine combined cycles (GTCC), which are vulnerable to damage from fine particles.

Thermo-chemical H₂O and/or CO₂ splitting using metal oxide reduction and oxidation reactions is a technology for H₂, CO and O₂ production. In this process, a metal oxide is first reduced through increasing of temperature or use of a reducing agent. The reduced metal oxide is then employed to split H₂O or CO₂. Thermo-chemical H₂O/CO₂ splitting is also a chemical looping process, in which the required heat can be supplied from concentrated solar thermal energy or any other sources. In this process also, as with CLC, the use of solid state oxygen carriers can lead to technical challenges.

In an endeavour to address the aforementioned limitations associated with particle damage, (but not that associated with the maximum temperature), US 2011/0117004 (Lamont et al) proposes the use of molten oxygen carriers in a CLC with a semi-batch reactor configuration. The use of a liquid OC avoids the use of particles, which are subject to damage as described above, and offers the potential to operate at higher temperature, although the configuration of Lamont does not achieve this. In the aforementioned system, fuel is initially introduced to the reduction reactor that is charged with the active metal oxide. The ensuing reactions result in the combustion of the fuel and the reduction of the active metal oxides. The fuel stream is then switched off and the air is introduced into the reactor to regenerate the active metal oxides. It is worth noting that, while a semi-batch reactor reduces the limitations of a batch reactor by offering continuous addition/removal of one or more streams of components, it retains significant disadvantages when converted to a continuous process. A configuration of two semi-batch reactors connected with a set of valves for continuous production of steam has been also proposed in US 2011/0117004, where the valves are used to periodically switch the fuel and air streams between the two semi-batch reactors. The active metal oxides proposed include the oxides of vanadium, manganese, copper, molybdenum, bismuth, iron, cobalt, nickel, zinc, tin, antimony, tungsten and lead.

However, the proposal in US 2011/0117004 has the following limitations:
Batch or semi-batch reactors are typically limited to relatively small-scale systems. This is because the size of the batch is limited by heat and mass-transfer considerations.
Batch and semi-batch processes are not truly steady state, but rather their output changes with time. This is because the mass fraction of unreacted material within the batch decreases exponentially with time from the start of a given batch process. This means that the conversion extent of product gases from the reactor also decreases with time for the case of a steady input of reactant gases. Hence, although various control strategies have been developed to partially compensate for this, they increase the cost and complexity of the system and a semi-batch process can never achieve a truly steady-state from a continuous process.
Semi-batch reactors are more complex because they rely on high temperature (and sometimes high pressure) valves to switch between reactors, thus limiting both their maximum temperature of operation and their reliability.

The above limitations imply that a much larger number of reactors would be required for continuous operation by a large-scale power plant or chemical process relative to a continuous process. This also increases their cost relative to continuous processes.

The proposed system also requires a coil to recover heat from the molten bed. However, the application of a heating coil within the pool of molten metal oxides requires materials with both high thermal conductivity and high resistance to corrosive environments. Furthermore, where the reactor is to generate high pressure steam, the material must also have resistance to pressure. Hence the limitation of available materials is a major barrier to the range of conditions in which this system can be implemented. In particular, the use of metals is limited because they are vulnerable to corrosion within the harsh environment of a molten metal oxide pool. This is especially true in the presence of oxygen within the air reactor. Similarly, while ceramics are an alternative material, they have the disadvantage of a lower thermal conductivity and are more vulnerable to thermal stresses. This limits their applicability to use in heating coils within a molten oxygen carrier.

The above requirement for nucleate boiling limits the Lamont system to steam cycles, whose temperature is typically limited to 600-700° C., depending on the pressure of the steam cycle, and hence its cost. On the other hand, many molten metals require significantly greater temperatures to be in the molten state. Hence this requirement either greatly restricts the choice of metals or results in inefficient operation due to the exergy destruction in the use of a higher temperature than is necessary. That is, many of the metal/metal oxides proposed in US 2011/0117004 have a melting temperature well above 700° C. and so are subject to this exergy loss.

The proposed system does not provide any feature for harnessing solar thermal energy.

It is against this background, and the problems and difficulties associated therewith, that the present invention has been developed.

### SUMMARY OF THE INVENTION

It is an object of the present invention to overcome or ameliorate at least one or more of the disadvantages of the prior art, or to provide a useful alternative.

According to a first aspect of the invention there is provided apparatus operable using concentrated solar radiation, the apparatus comprising:

a body having a cavity adapted to receive concentrated solar radiation;

a heat energy absorber associated with the cavity to receive heat from concentrated solar radiation within the cavity;

a chamber containing a body of matter, the chamber being in heat exchange relation with the heat energy absorber to receive heat therefrom for heating the body of matter; and

an inlet means for introducing fluid into the chamber for contacting the contained body of matter.

The apparatus may comprise:
(i) a solar receiver whereby the heat energy absorber receives heat energy from the concentrated solar radiation; or
(ii) a hybrid receiver-combustor whereby the heat energy absorber receives heat energy from the concentrated solar radiation and also from combustion within the cavity (either in combination or separately, depending for example upon the manner in which the hybrid receiver-combustor is operating and the availability of incident solar radiation).

The fluid introduced into the chamber for contacting the body of matter contained therein may be treated through contact with the contained body of matter.

The body of matter contained within the chamber will hereinafter be referred to variously as the contained matter or the contained body of matter.

The treatment to which the fluid is subjected may, for example, comprise heating of the fluid with heat received from the contained body of matter, or causing the fluid to undergo a process or reaction with the contained body of matter, or a combination thereof.

More particularly, the fluid introduced into the chamber for contacting the contained body of matter may be heated through contact with the contained body of matter.

Alternatively, or additionally, the fluid introduced into the chamber for contacting the contained body of matter may react with the contained matter or at least a portion thereof. The reaction may comprise one or more multi-phase reactions.

The apparatus may further comprise an outlet means for removing a gaseous fluid from the chamber. The gaseous fluid may comprise gaseous fluid separating from the contained body of matter. The gaseous fluid may comprise a heated form of the fluid introduced into the chamber. Additionally or alternatively, the gaseous fluid may comprise a gaseous product(s) of a reaction within the chamber.

The material which constitutes the body of matter contained within the chamber may be of any appropriate form, including for example a liquid or mixture of liquids, or a multiphase (heterogeneous) fluid. More particularly, the material may comprise miscible or immiscible liquids, as well as solid phase material(s).

The multiphase fluid may include a solid phase or different liquid phases. The solid phase of the multiphase fluid may comprise particles.

The solid phase of the multiphase fluid may melt and/or react with the fluid introduced into the chamber for contacting the contained body of matter. More particularly, the multiphase fluid may be introduced into the chamber with a solid phase or solid phases. The solid phase(s), or at least a portion thereof, may be caused to melt in response to heat imparted to the body of matter contained within the chamber (e.g. from heat derived from the concentrated solar radiation and/or combustion in the case of a hybrid receiver-combustor). Additionally, or alternatively, the solid phase(s), or at least a portion thereof, may be caused to react with fluid introduced into the chamber for contacting the contained body of matter.

The change in the phase of component materials within the multiphase fluid may be intended for energy storage, hybridization, material processing, and the like, as would be understood by a person skilled in the art.

The apparatus may be used for melting, heating or reacting of solid materials within the contained matter, typically in the form of particles.

The apparatus may be used for performing reactions between the matter contained within the chamber and the fluid which is introduced into the contained matter. The reactions may comprise multi-phase reactions.

The material which constitutes the body of matter contained within the chamber may be confined within the chamber or it may be transported through the chamber. In being transported through the chamber, the material within the chamber may be exchanged, either periodically or continuously. This may facilitate continuous and semi-batch modes of operation of the apparatus.

Where the material which constitutes the body of matter contained within the chamber is transported through the chamber, the apparatus may be provided with means for introducing material into the chamber and means for removing material from the chamber. With this arrangement, fresh material is introduced into the chamber and correspondingly excess material is removed from the chamber, with the material resident in the chamber at any time constituting the body of matter within the chamber.

The matter contained within the chamber may be of any appropriate type. The unique thermo-chemical and thermo-physical properties of liquid metal/metal oxides referred to earlier make liquid metal/metal oxide particularly suitable for use as the matter contained within the chamber. However, the matter contained within the chamber is not limited to liquid metal/metal oxide. The matter contained within the chamber may be any kind of heat transfer fluid with appropriate thermo-physical and thermo-chemical properties. Any metal/metal oxides, molten salt, molten alloys or combination of different metal/metal oxides, such as Ga, Sb, Pb, Sn, Fe, Cu, Cr, Ti, CuO and AgO or combinations of different molten salts may be employed. The invention is not limited to the above-mentioned liquids; for example, other heat transfer liquids such as nano-fluids and non-metallic fluids or molten salts with the appropriate thermo-physical and thermo-chemical properties may also be employed in the embodiments disclosed herein.

The fluid which is introduced into the chamber for contacting the body of contained matter may comprise a gaseous fluid, in which case it is introduced into the contained matter as a gas. Other arrangements are contemplated. By way of example, the fluid may be introduced into the chamber as a vapour or as a liquid which is vaporised upon contact with the contained matter. In the case where the matter contained within the chamber comprises a liquid, the fluid introduced into the chamber for contacting the body of contained matter may comprise a liquid with a lower boiling point than the liquid contained within the chamber, causing it to vaporise upon contact with the latter.

The gas may be a reactant gas or a non-reactant gas with respect to the heat transfer liquid. The gas may be also a combination of different component gases.

In a particular embodiment, the fluid introduced into the chamber for contacting the body of contained matter (e.g. the heat transfer liquid) comprises air. The resultant heated air may be intended for use in a combustion process or a chemical reaction, although other applications are contemplated as would be understood by a person skilled in the art. In another embodiment, the fluid introduced into the chamber may be an inert gas such as N₂, He, Ar or CO₂. The invention is not, however, limited to air or inert gases and can be employed for any kind of gas or gases, either gases that are reactive or non-reactive with the contained matter (e.g. the heat transfer liquid).

The apparatus may be used as a reactor in which different inlet gases react while the matter contained within the chamber is used either as a catalyst or as a heat transfer medium.

The apparatus may be used as a reactor, in which a single or multiphase liquid reacts with a single gas or different gases. In this way, the apparatus may be used as a reactor for multiphase reactions.

The body may comprise an aperture through which concentrated solar radiation can be received within the cavity.

The aperture may be provided with a secondary concentrator.

The aperture may be fitted with an aerodynamic seal to decrease convective heat losses.

Preferably, the body is insulated to prevent or minimise heat dissipation.

A refractory liner may be provided around the chamber.

The body may comprise a common wall between the cavity and the chamber.

The common wall may present a surface defining an absorber surface within the cavity or bounding part of the cavity.

Preferably, the chamber is defined by a pressure vessel, with a wall of the pressure vessel defining the common wall between the chamber and the cavity.

Preferably, the cavity and the chamber are integrated into the vessel.

The heat energy absorber may be disposed substantially around the cavity.

The heat energy absorber and the aperture may cooperate to define the boundary of the cavity.

The apparatus may be mounted in any orientation, but preferably with the aperture facing the solar source.

Where the contained matter comprises a liquid (e.g. the heat transfer liquid), the body of liquid would have a lower portion and an upper portion whatever the orientation.

Where the contained matter comprises a liquid (e.g. the heat transfer liquid), the volume of the body of liquid is preferably less than the volume of the chamber, whereby the upper portion of the liquid defines a surface, and a gas collection space is established within the chamber above the surface. With this arrangement, fluid separating from the body of liquid as a heated gaseous fluid can accumulate in the gas collection space, from where it can leave the chamber via the outlet means.

The inlet means for introducing fluid into the chamber for contacting the body of contained matter may be adapted to inject the fluid under pressure into the contained matter (e.g. the heat transfer liquid).

The inlet means may comprise a sparger where the fluid comprises a gas.

The inlet means may comprise a single inlet or a plurality of inlets.

The outlet means may comprise a single outlet or a plurality of outlets.

According to a second aspect of the invention there is provided apparatus operable using concentrated solar radiation, the apparatus comprising:

a body having a cavity adapted to receive concentrated solar radiation;

a heat energy absorber associated with the cavity to receive heat from concentrated solar radiation within the cavity;

a chamber containing a body of matter, the chamber being in heat exchange relation with the heat energy absorber to receive heat therefrom for heating the body of matter;

an inlet means for introducing fluid into the contained body of matter, with fluid separating from the body of matter as a gaseous fluid; and

an outlet means for removing the separated gaseous fluid from the chamber.

According to a third aspect of the invention there is provided apparatus for treating a liquid using concentrated solar radiation, the apparatus comprising:

a body having a cavity adapted to receive concentrated solar radiation;

a heat energy absorber associated with the cavity to receive heat from concentrated solar radiation within the cavity;

a chamber containing a body of matter, the chamber being in heat exchange relation with the heat energy absorber to receive heat therefrom for heating the body of matter;

an inlet means for introducing liquid(s) to be treated into the contained body of matter, with fluid separating from the body of matter as a treated liquid(s); and

an outlet means for removing the separated liquid(s) from the chamber.

According to a fourth aspect of the invention there is provided a solar receiver for treating a gas, the solar receiver comprising:

a body having a cavity adapted to receive concentrated solar radiation;

a heat energy absorber associated with the cavity to receive heat from concentrated solar radiation within the cavity;

a chamber containing a body of matter, the chamber being in heat exchange relation with the heat energy absorber to receive heat therefrom for heating the body of matter;

an inlet means for introducing gas into the contained body of matter for heat exchange therewith; and

an outlet means for removing treated gas separated from the body of matter.

According to a fifth aspect of the invention there is provided a solar receiver for heating a gas, the solar receiver comprising:

a body having a cavity adapted to receive concentrated solar radiation;

a heat energy absorber associated with the cavity to receive heat from concentrated solar radiation within the cavity;

a chamber containing a body of heat transfer liquid, the chamber being in heat exchange relation with the heat energy absorber to receive heat therefrom for heating the heat transfer liquid;

an inlet means for introducing gas into the body of heat transfer liquid for heat exchange therewith; and

an outlet means for removing heated gas separated from the heat transfer liquid.

According to a sixth aspect of the invention there is provided a method of treating a fluid, the method comprising use of apparatus according to the first, second or third aspect of the invention.

The fluid to be treated may comprise a reactant gas or a non-reactant gas with respect to the heat transfer liquid.

The gas may comprise a mixture of different gases or a pure substance. Different gases may be injected through various inlets.

The treatment to which the fluid is subjected may, for example, comprise heating of the fluid with the heat transfer liquid, or causing the fluid to undergo a reaction with the heat transfer liquid, or a combination thereof. The heat transfer fluid may also be a combination of liquid and solid phases, which may either undergo a reaction with the gases or not react with the gases.

According to a seventh aspect of the invention there is provided a method of treating a gas, the method comprising use of a solar receiver according to the fourth or fifth aspect of the invention.

The treatment to which the gas is subjected may, for example, comprise heating of the gas with the heat transfer liquid, or causing the gas to undergo a reaction with the heat transfer liquid, or a combination thereof.

According to an eighth aspect of the invention there is provided a method of heating a gas, the method comprising use of a solar receiver according to the fourth or fifth aspect of the invention.

According to a ninth aspect of the invention there is provided a method of heating a fluid, the method comprising:

heating a body of heat transfer liquid;

introducing fluid to be heated into the heated body of heat transfer liquid;

separating the fluid from the body of heat transfer liquid as a heated gaseous fluid; and

collecting the separated gaseous fluid.

The fluid may comprise a reactant gas or a non-reactant gas with respect to the heat transfer liquid. The fluid may also be multiphase (heterogeneous) including solid phase or different liquid phases.

The method may further comprise use of concentrated solar radiation to heat the body of heat transfer liquid.

The method may further comprise introducing fluid to be heated into a lower portion of the body of heat transfer liquid and separating the heated gaseous fluid from an upper portion of the of the body of heat transfer liquid.

The heated gaseous fluid may be separated from an upper portion of the body of heat transfer liquid by allowing the gaseous fluid to be liberated at an upper surface of the body of heat transfer liquid.

The method may further comprise heating and melting a solid phase.

The method may further comprise introducing fluid to be heated into a lower portion of the body of heat transfer liquid as a gas, the gas being injected under pressure into the body of heat transfer liquid.

The method may further comprise an asymmetric arrangements of jets, in a particular embodiment, the jets may be asymmetrically distributed on one side of the cavity to generate a large-scale circulation of the heat transfer fluid around the cavity as the bubbles on that side rise to the surface.

The method may further comprise direct heating of a HTF within a cavity receiver. The heated HTF may be employed to heat a gas or may undergo a reaction in another bubble column, while it is circulating between the cavity receiver and the bubble column.

The method may further comprise direct heating of a HTF within a cavity receiver in which a gas is heated or undergoes reactions with the HTF.

The method may further comprise introducing fluid to be heated into a lower portion of the body of heat transfer liquid as a vapour or as a liquid which is vaporised upon contact with the heat transfer liquid, the vapour or liquid being injected under pressure into the body of heat transfer liquid.

The method may further comprise collecting the separated gaseous fluid in a collection space above the body of heat transfer liquid and removing the collected gaseous fluid from the collection space.

According to a tenth aspect of the invention there is provided a method of heating a gas, the method comprising:

receiving concentrated solar radiation;

heating a body of heat transfer liquid using thermal energy derived from the concentrated solar radiation;

introducing gas to be heated into the heated body of heat transfer liquid;

separating the gas from the body of heat transfer liquid; and

collecting the separated gas.

According to an eleventh aspect of the invention there is provided a method of performing a process using a first fluid and second fluid, the method comprising:

receiving concentrated solar radiation;

applying thermal energy derived from the concentrated solar radiation to the first fluid; and

introducing the second fluid into the first fluid.

The process may comprise a chemical process. The chemical process may involve chemical reaction between the first and second fluids, or at least portions thereof.

The first fluid may comprise a liquid or a multiphase fluid. The liquid may comprise a heat transfer liquid. The multiphase fluid may include a solid phase or different liquid phases. The solid phase of the multiphase fluid may comprise particles.

The second fluid may comprise a gas. The gas may be injected under pressure into the first fluid.

The second fluid may be introduced into the first fluid as a vapour or as a liquid which is vaporised upon contact with the first fluid, the vapour or liquid being injected under pressure into the first fluid.

The first fluid may be contained within a chamber in which the process is to be performed.

The method may further comprise removing gaseous product(s) of the process (e.g. chemical reaction) performed within the chamber.

The first fluid may be confined within the chamber or it may be transported through the chamber. In being transported through the chamber, the first fluid may be exchanged, either periodically or continuously.

According to a twelfth aspect of the present invention there is provided a reactor system for contacting a reactant liquid with two gaseous reactants, the reactor system comprising two reactors interconnected for circulation of a reactant liquid therebetween, whereby the circulating reactant liquid is enabled to react with a gaseous reactant introduced into one reactor and to also react with a gaseous reactant introduced into the other reactor.

Preferably, each reactor defines a reaction chamber through which the reactant liquid is able to circulate and further comprises an inlet means for introducing the gaseous reactants into the reaction chamber and an outlet means for removal of gaseous fluid (gaseous products) from the reaction chamber.

Either one or both reactors may be configured to be heated either directly or indirectly with concentrated solar energy. In this specification, directly heated refers to the use of a cavity solar receiver, and indirectly heated refers to the use of an intermediate heat transfer medium (such as a working fluid or an absorption wall), which is used to transfer absorbed concentrated solar thermal energy from a solar receiver to heat the liquid within the bubble reactor. However, other types of introduction of the solar thermal energy into the system may, of course, be used.

Particular embodiments of the systems disclosed herein may be used in any chemical looping process in which heat is needed to be supplied from an external source such as thermo-chemical splitting of H₂O and CO₂ using a liquid oxygen carrier or molten salt chemical looping for separation of HBr in halogen-based natural gas conversion process.

The gaseous reactants introduced into the two reaction chambers may be used as motive power for circulation of reactant liquid between the two reactors.

More particularly, each of the two reactors may be configured as a gas-lift reactor, and may optionally be configured such that the two gas-lift reactors are interconnected such that the lift (upward flow) generates circulation of reactant liquid between the two reactors. Accordingly, the driving force required for circulation of reactant liquid between the two reactors may be generated hydrodynamically. This may be achieved by interconnecting the two reactors so that upward flow exiting from an upper section of each reactor is introduced into a lower section of the other reactor, thereby establishing a continuous circulation of the reactant liquid between two reactors.

With this arrangement, the two reactors may comprise bubble reactors, each functioning as a riser, in which the injection of reactant gas induces a lift that circulates the reactant liquid between the two reactors.

The hydrodynamic circulation of the reactant liquid is particularly advantageous for the circulation of liquids under challenging conditions such as under high operating temperatures and pressures, or in aggressive environments such as with reductive or oxidative chemicals. These conditions may be technically too challenging for the use of pumps to circulate the high temperature molten oxygen carrier between the bubble reactors

Means may be provided for removing entrained gas bubbles from the flow of reactant liquid exiting each reactor. Such means may comprise a gas trap employed to separate entrained bubbles from the reactant liquid prior to introduction of the reactant liquid to the other reactor. This is to avoid the mixing of the different gaseous reactants.

The reactor system may be used for liquid chemical looping combustion (LCLC) or for liquid chemical looping gasification (LCLG), with the reactant liquid comprising an oxygen carrier. The reactor system may alternatively be used in a chemical process in which a liquid undergoes reactions with different type of gases. By way of example, the reactant liquid may comprise a high temperature molten metal oxide functions as the oxygen carrier. As alluded to above, the hydrodynamic circulation of the oxygen carrier is particularly advantageous under challenging conditions such as under high operating temperatures and pressures, or in aggressive environments such as with reductive or oxidative chemicals, as occurs with LCLC and LCLG systems. These conditions are expected to be technically too challenging for the use of pumps to circulate the high temperature molten oxygen carrier between the bubble reactors.

In use of reactor system for LCLC or for LCLG, with the reactant liquid comprising an oxygen carrier, one reactor may comprise a fuel reactor and the other reactor may comprise an air reactor. With this arrangement, one gaseous reactant comprises a gaseous fuel and the other gaseous reactant comprises air.

The reactor system may be implemented in a power cycle involving power generation with gas turbines, although other high temperature processes and other power cycles are contemplated.

According to a thirteenth aspect of the present invention there is provided a method of contacting a reactant liquid with two gaseous reactants, the method comprising use of apparatus according to the twelfth aspect of the invention.

According to a fourteenth aspect of the present invention there is provided a method of contacting a reactant liquid with two gaseous reactants, the method comprising circulating the reactant liquid between two reactors, introducing one gaseous reactant into one reactor and introducing the other gaseous reactant into the other reactor, whereby the circulating reactant liquid is enabled to react with gaseous reactant introduced into one reactor and to also react with gaseous reactant introduced into the other reactor

Preferably, the method according to the fourteenth aspect of the invention further comprises using the gaseous reactants introduced into the two reactors as motive power for circulation of reactant liquid between the two reactors.

According to a fifteenth aspect of the invention there is provided a method of performing liquid chemical looping combustion (LCLC) or for liquid chemical looping gasification (LCLG), wherein the method comprises use of apparatus according to the twelfth aspect of the invention and wherein with the reactant liquid comprises an oxygen carrier.

According to a sixteenth aspect of the present invention there is provided a method of performing liquid chemical looping combustion (LCLC) or for liquid chemical looping gasification (LCLG), the method comprising circulating a reactant liquid comprising an oxygen carrier between a fuel reactor and an air reactor, introducing a fuel into the fuel reactor and introducing air into the air reactor, whereby the circulating reactant liquid is enabled to react with fuel introduced into the air reactor and to also react with air introduced into the air reactor.

Preferably, the method according to the sixteenth aspect of the invention further comprises using gaseous fuel, or a solid fuel together with a gas such as steam or CO₂, and air introduced into the two reactors as motive power for circulation of the oxygen carrier between the two reactors.

### BRIEF DESCRIPTION OF THE DRAWINGS

Notwithstanding any other forms which may fall within the scope of the present invention, a preferred embodiment/preferred embodiments of the invention will now be described, by way of example only, with reference to the accompanying drawings in which:

FIG. 1 shows a schematic sectional view of a first embodiment of a solar receiver apparatus;

FIG. 2 shows a schematic sectional view of a second embodiment of a solar receiver apparatus;

FIG. 3 shows a schematic sectional view of a third embodiment of a solar receiver apparatus in the form of a high temperature solar bubble receiver/reactor in a billboard configuration;

FIG. 4 shows a schematic sectional view of a fourth embodiment of a solar receiver apparatus in the form of a high temperature solar bubble receiver/reactor in a surround field configuration;

FIG. 5A shows a schematic sectional view of a first embodiment of the high temperature solar bubble receiver/reactor with indirectly heated bubble columns;

FIG. 5B shows a schematic sectional view of a second embodiment of the high temperature solar bubble receiver/reactor with indirectly heated bubble columns;

FIG. 5C shows a schematic sectional view of a third embodiment of the high temperature solar bubble receiver/reactor with a circulating fluid;

FIG. 6 shows a schematic representation of a directly heated solar cavity bubble receiver/reactor in a vertical orientation;

FIG. 7 shows a schematic view of an embodiment of a reactor system according to the invention;

FIG. 8 shows a schematic view of an embodiment of a continuous liquid chemical combustion/gasification system featuring a reactor system as shown in FIG. 7;

FIG. 9 shows a schematic view of an embodiment of a reactor system according to the invention, which is heat directly by concentrated solar thermal energy; and

FIG. 10 shows a proposed directly heated solar receiver/reactor with circulating heat transfer fluid.

### DEFINITIONS

The following definitions are provided as general definitions and should in no way limit the scope of the present invention to those terms alone, but are put forth for a better understanding of the following description.

Unless defined otherwise, all technical and scientific terms used herein have the same meaning as commonly understood by those of ordinary skill in the art to which the invention belongs. It will be further understood that terms used herein should be interpreted as having a meaning that is consistent with their meaning in the context of this specification and the relevant art and will not be interpreted in an idealized or overly formal sense unless expressly so defined herein. For the purposes of the present invention, additional terms are defined below. Furthermore, all definitions, as defined and used herein, should be understood to control over dictionary definitions, definitions in documents incorporated by reference, and/or ordinary meanings of the defined terms unless there is doubt as to the meaning of a particular term, in which case the common dictionary definition and/or common usage of the term will prevail.

For the purposes of the present invention, the following terms are defined below.

The articles “a” and “an” are used herein to refer to one or to more than one (i.e. to at least one) of the grammatical object of the article. By way of example, “an element” refers to one element or more than one element.

The term “about” is used herein to refer to quantities that vary by as much as 30%, preferably by as much as 20%, and more preferably by as much as 10% to a reference quantity. The use of the word ‘about’ to qualify a number is merely an express indication that the number is not to be construed as a precise value.

Throughout this specification, unless the context requires otherwise, the words “comprise”, “comprises” and “comprising” will be understood to imply the inclusion of a stated step or element or group of steps or elements but not the exclusion of any other step or element or group of steps or elements.

Any one of the terms “including” or “which includes” or “that includes” as used herein is also an open term that also means including at least the elements/features that follow the term, but not excluding others. Thus, “including” is synonymous with and means “comprising”.

In the claims, as well as in the summary above and the description below, all transitional phrases such as “comprising”, “including”, “carrying”, “having”, “containing”, “involving”, “holding”, “composed of”, and the like are to be understood to be open-ended, i.e. to mean “including but not limited to”. Only the transitional phrases “consisting of” and “consisting essentially of” alone shall be closed or semi-closed transitional phrases, respectively.

Although any methods and materials similar or equivalent to those described herein can be used in the practice or testing of the present invention, preferred methods and materials are described. It will be appreciated that the methods, apparatus and systems described herein may be implemented in a variety of ways and for a variety of purposes. The description here is by way of example only.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The phrase “and/or”, as used herein in the specification and in the claims, should be understood to mean “either or both” of the elements so conjoined, i.e. elements that are conjunctively present in some cases and disjunctively present in other cases. Multiple elements listed with “and/or” should be construed in the same fashion, i.e. “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e. the inclusion of at least one, but also including more than one, of a number or list of elements, and, optionally, additional unlisted items. Only terms clearly indicated to the contrary, such as “only one of” or “exactly one of”, or, when used in the claims, “consisting of” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either”, “one of”, “only one of”, or “exactly one of”. “Consisting essentially of”, when used in the claims, shall have its ordinary meaning as used in the field of patent law.

As used herein in the specification and in the claims, the phrase “at least one”, in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B”, or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

For the purpose of this specification, where method steps are described in sequence, the sequence does not necessarily mean that the steps are to be carried out in chronological order in that sequence, unless there is no other logical manner of interpreting the sequence.

In addition, where features or aspects of the invention are described in terms of Markush groups, those skilled in the art will recognise that the invention is also thereby described in terms of any individual member or subgroup of members of the Markush group.

### DETAILED DESCRIPTION OF THE INVENTION

It should be noted in the following description that like or the same reference numerals in different embodiments denote the same or similar features.

### Solar Receiver

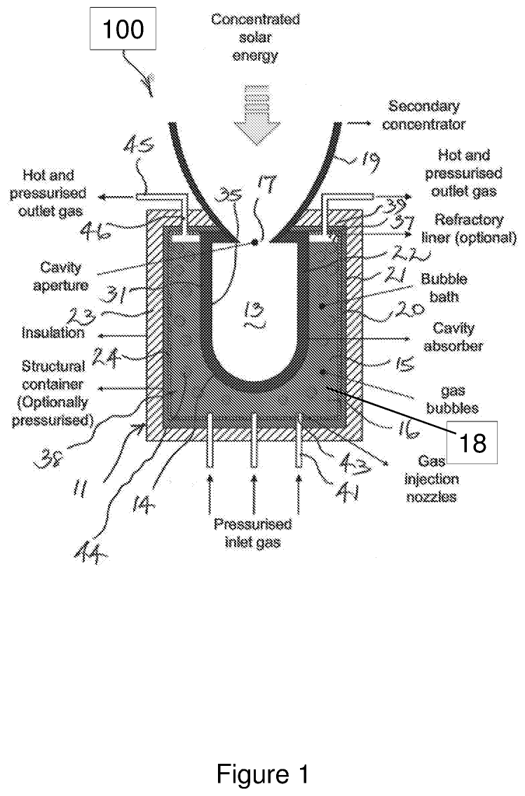

Referring to FIG. 1, there is depicted a first embodiment of apparatus in the form of a solar receiver 100 used in association with a solar source (not shown) that is beamed down into the solar receiver, for example from a secondary concentrator mounted on top of a solar tower. This allows it to capture the heat energy from the solar source and transfer the heat to a pressurised gas. The pressurised gas may comprise air for use in a combustion process; for example, for power generation. Other forms of gas, and other applications of the heated gas, are contemplated; for example, the heated gas may be used in a chemical process.

The solar receiver 100 comprises a receiver body 11 having a cavity 13 adapted to receive concentrated solar radiation from the solar source, a heat energy absorber 14 associated with the cavity 13 to receive heat from concentrated solar radiation within the cavity, and a chamber 15 containing a body 16 of matter 16. In this embodiment, the body of matter 16 comprises heat transfer liquid 18 for transferring the heat to a pressurised gas, as will be explained in more detail later. In the arrangement illustrated, the heat transfer liquid 18 is confined within the chamber 15; that is, it is not transported through the chamber.

The receiver body 11 has an aperture 17 through which concentrated solar radiation can be received within the cavity 13 to insulate the cavity (i.e. to expose the cavity to the sun's rays).

The receiver body 11 may optionally be fitted with a secondary concentrator 19 associated with the aperture 17. The secondary concentrator 19 may comprise a compound parabolic concentrator.

The aperture 17 may be fitted with an aerodynamic seal (not shown) to decrease convective heat losses.

The receiver body 11 may further comprise a vessel 20 configured as a structural container having an outer wall 21 and an inner wall 22 between which the chamber 15 is defined. The vessel 20 may be constructed as a pressure vessel for sustaining fluid pressure within the chamber 15.

The outer wall 21 may optionally be insulated to prevent or minimise heat dissipation. Specifically, the outer wall 21 is lined externally with insulation 23 in the arrangement shown.

The outer wall 21 may also optionally be provided with an interior refractory liner 24.

The heat energy absorber 14 and the aperture 17 cooperate to define the boundary of the cavity 13. In this way, the heat energy absorber 14 is disposed substantially around the cavity 13, as can be seen in FIG. 1.

The inner wall 22 of the vessel 20 defines a common wall 31 between the chamber 15 and the cavity 13. The common wall 31 extends to and is integrated with the aperture 17.

The common wall 31 presents an absorber surface 35 around the cavity 13. Concentrated solar radiation received within the cavity 13 heats the absorber surface 35. The heat is transferred through the common wall 31 to the body 16 of heat transfer liquid 18 within the chamber 15.

The heat transfer liquid 18 may comprise a liquid metal/metal oxide, although it is not limited thereto. The heat transfer liquid 18 may be any kind of heat transfer fluid with appropriate thermo-physical properties. Any metal/metal oxides, molten alloys or combination of different metal/metal oxides such as Ga, Sb, Pb, Sn, Fe, Cu, Cr, Ti, CuO and AgO, or alternatively non-metallic fluids with the appropriate thermo-physical properties such as, for example, molten salts, may be employed, as mentioned above. Other heat transfer liquids such as nano-fluids and non-metallic fluids may also be used.

The volume of the body 16 of heat transfer liquid 18 is less than the volume of the chamber 15, whereby the upper portion of the heat transfer liquid 18 defines a surface 37, and a gas collection space 39 is established within the chamber 15 above the surface 37. With this arrangement, pressurised gas separating from the body 16 of heat transfer liquid 18 as a heated gaseous fluid can accumulate in the gas collection space 39, as will be explained shortly.

An inlet means 41 is provided for introducing pressurised gas (e.g. air) into the bottom section of the body 16 of heat transfer liquid 18 within the chamber 15. In the arrangement shown, the inlet means 41 comprises several inlets 43, each of which may comprise a sparger or injection nozzle. The pressurised gas may comprise a mixture of different gases or a pure substance. Different gases may be injected through various inlets 43.

The pressurised gas (for example, either e.g. air, N₂, Ar or CO₂) is injected into the bottom section of the body 16 of heat transfer liquid 18, forming gas bubbles 44 within liquid. The gas bubbles 44 rise to the surface 37 of the body 16 of heat transfer liquid 18, adsorbing heat in the process. The arrangement thus provides a heat transfer fluid bath 38. The pressurised gas leaves the heat transfer liquid 18 at the surface 37 and enters the gas collection space 39. The gas collection space 39 also allows the heat transfer liquid 18 to expand freely, for example, in response to gas injection, thermal expansion and the like.

An outlet means 45 is provided for the pressurised heated gas to be removed from the collection space 39 for a subsequent use. In the arrangement shown, the outlet means 45 comprises several outlets 46.

The shape of the cavity 13 depicted in the accompanying drawings is illustrative only; other configurations are possible, as would be understood by a person skilled in the art.

In operation, concentrated solar radiation received within the cavity 13 is first absorbed on the absorber surface 35 on the inner side of the heat energy absorber 14. The absorbed heat is then transferred via the heat transfer liquid 18 within chamber 15 to the pressurised gas, which is injected as bubbles through into the heat transfer fluid bath 38 and subsequently retrieved.

In the first embodiment, the receiver body 11 is configured for orientation vertically in a beam down arrangement, with the aperture 17 upwardly facing, as shown in FIG. 1.

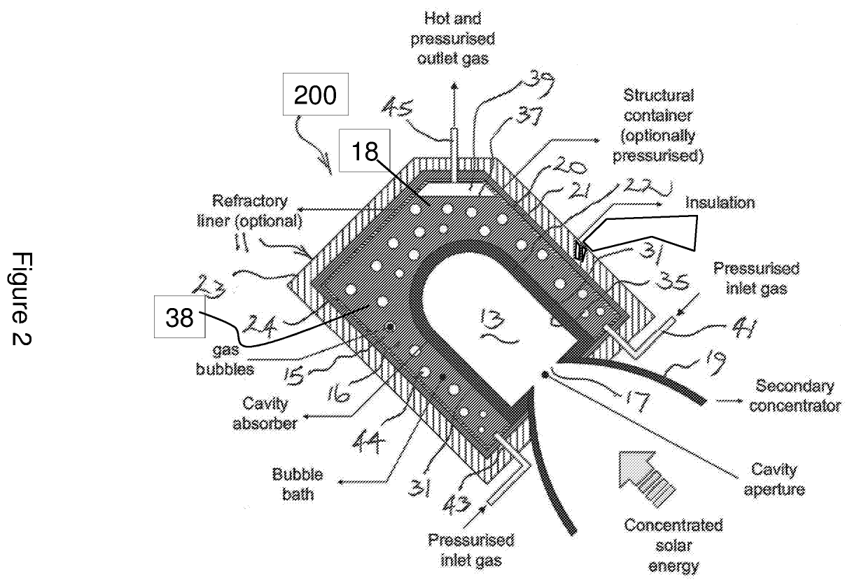

In FIG. 2, there is depicted a further embodiment 200 of the solar receiver 100 in which the receiver body 11 is configured to be mounted on top of a tower or dish concentrator, so that the orientation of its axis is directed angularly downward. In FIG. 2 like reference numerals are utilised to identify like components of solar receiver 200. With this arrangement, the aperture 17 is facing downwardly in alignment with the incoming beam of upwardly directed concentrated solar radiation. Other configurations are also contemplated, as would be understood by a person skilled in the art.

In the first and second embodiments, the heat transfer liquid 18 (or other matter constituting the body 16) is confined within the chamber 15; that is, the heat transfer liquid 18 (or other matter constituting the body 16) is not transported through the chamber to provide fluid exchange within the chamber.

In another embodiment (not shown), the heat transfer liquid 18 (or other matter constituting the body 16) may be exchanged, either periodically or continuously during operation of the apparatus. In other words, material constituting the body 16 of matter may be transported through the chamber. This may facilitate continuous and semi-batch modes of operation of the apparatus. The heat transfer liquid 18 (or other matter constituting the body 16) leaving the chamber 15 carries thermal energy which can then be extracted and exploited, as would be recognised by a person skilled in the art.

Where the material which constitutes the body 16 of matter contained within the chamber 15, is transported through the chamber 15 and thereby exchanged, the apparatus may be provided with means for introducing the material into the chamber 15, and means for removing the material from the chamber. With this arrangement, fresh material is introduced into the chamber 15, and correspondingly excess material is removed from the chamber, with the material resident in the chamber at any time constituting the body 16 of matter within the chamber.

In the embodiments described, the material constituting the body 16 of matter contained within the chamber 15 comprises a heat transfer liquid 18. The body 16 of matter contained within the chamber 15 may, however, be of any other appropriate form, including a liquid or mixture of liquids, or a multiphase (heterogeneous) fluid, as discussed previously. The multiphase fluid may be introduced into the chamber 15 with a solid phase or solid phases. The solid phase(s), or at least a portion thereof, may be caused to melt in response to heat derived from the concentrated solar radiation and also from combustion within the cavity (either in combination or separately, depending upon the manner in which the hybrid receiver-combustor is operating and the availability of incident solar radiation). Additionally, or alternatively, the solid phase(s), or at least a portion thereof, may be caused to react with fluid to be treated, the latter being introduced into the body 16 of matter (e.g. the heat transfer fluid) contained within the chamber 15.

From the foregoing, it is evident that the various embodiments each provide a simple yet highly effective way of heating or otherwise treating a gaseous fluid using thermal energy derived from a solar source. In the embodiments described, the thermo-chemical and thermo-physical properties of liquid metal/metal oxides are exploited in the heat transfer process. Any metal/metal oxides, molten alloys or combination of different metal/metal oxides such as Ga, Sb, Pb, Sn, Fe, Cu, Cr, CuO, Cu2O, AgO and Ag2O or even non-metallic fluids and molten salts with the appropriate thermo-physical and thermo-chemical properties or even non-metallic fluids or multiphase fluids, can be employed for heating of different gases or performing multiphase reactions.

The embodiments described overcome or at least reduce the effect of certain deficiencies of the prior art described earlier as follows:

Elimination of the technical complications associated with the use of reticulated porous ceramic (RPC), including both low thermal conductivity, gas-tightness and need for gap between the RPC and receiver wall, through application of a molten metal oxide such as cuO_{δ}_{₁}(l) with a thermal conductivity of around 160-180 (Wm−1K−1) in the temperature range of 1300-1600 K.
(a) Mitigation of the re-radiation heat losses, through elimination/reduction of the temperature gradient between the solar cavity and the gas heating zone. This is achieved with each of the present embodiments by the high thermal conductivity of the molten metal oxide compared with RPC, the turbulence induced through injection of the air within the air heating zone and the direct contact of air with the hot molten metal/metal oxides.
(b) Elimination or greatly reducing the temperature gradients inside the solar cavity by the use of more uniform heat transfer rates within the gas heating zone. Furthermore, the present embodiments each enables a better control of the temperature distribution through both design of the arrangement of the gas nozzles and gas flow rate in each nozzle, whereby an adequate number of nozzles and/or sufficient gas flow rates can be employed to decrease and control the temperature of those parts of solar cavity that receive higher solar radiation than the other sections.

In the embodiments described and illustrated, the apparatus is configured as a solar receiver for capturing heat energy from a solar source. The apparatus may, however, be configured as a hybrid receiver-combustor for capturing heat energy from a solar source and a fuel source, as would be understood by a person skilled in the art. In the latter case, the hybrid receiver-combustor is adapted to capture heat energy from a solar source and accommodate combustion to generate heat from a fuel source.

In the embodiments described and illustrated, the apparatus, in effect, treats the gas (e.g. air) by heating it. In other embodiments, the gas may be treated in another way as would be understood by a person skilled in the art; for example, the gas may be treated by way of a reaction with the heat transfer liquid.

Accordingly, the gas to be treated may comprise a reactant gas or a non-reactant gas with respect to the heat transfer liquid.

In the embodiments described and illustrated, the apparatus is configured as a solar receiver for capturing heat energy from a solar source for heating purposes. The apparatus may, however, be also configured as a solar receiver/reactor to employ captured heat to perform chemical reactions. It may be also configured as a hybrid solar receiver-combustor to provide the heat for performing chemical reactions from a solar source and a fuel source.

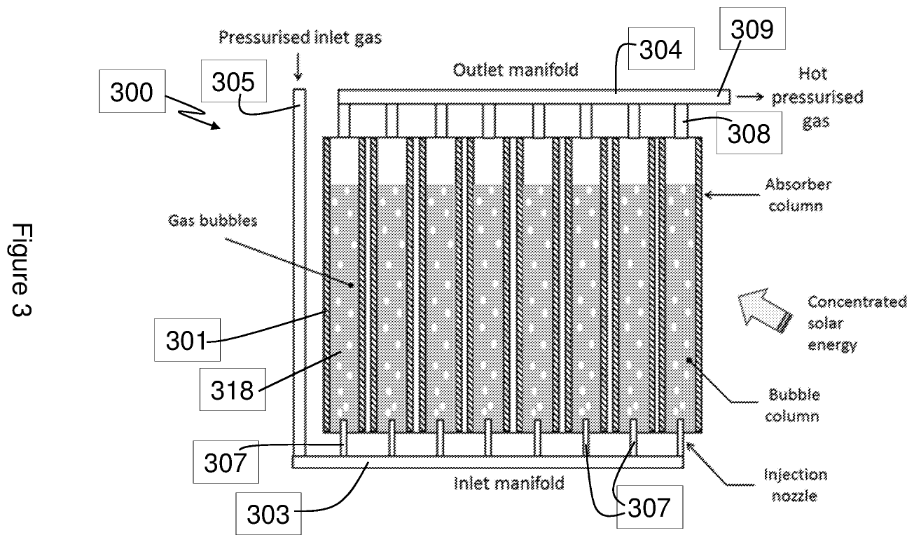

Referring now to FIG. 3 there is depicted a schematic representation 300 of a high temperature solar bubble receiver/reactor in a billboard configuration. This system employs at least on (plurality shown) bubble column 301 of a heat transfer fluid 318 (HTF) (e.g. molten, metal/metal oxide) within a billboard style of solar receiver 100. The introduced concentrated solar radiation into the billboard receiver 300 is first absorbed on the outer side of the bubble columns (shown as absorber column 301 in FIG. 3). The absorbed heat is then transferred to HTF 318, which is inside the columns 301, and finally used to heat the pressurised gas, which is distributed to each column 301 via a manifold 303 connected to pressurised gas inlet 305.

The system is shown schematically here for eight bubble columns 318. However, it is readily apparent that various numbers and configurations of the bubble columns and billboard solar receiver configurations can be employed as would be appreciated by the skilled addressee.

The pressurised gas is injected through nozzles 307 at the bottom of each absorber column 301 housing a molten metal/metal oxide HTF 318, to augment both the heat transfer to the molten metal/oxide 318 and achieve high rates of heat and mass transfer to the gas. The pressurised gas is injected as bubbles through injection nozzles 307 into the HTF 318. Heated pressurised gas exits the HTF 318 and absorber column 301 via outlet nozzle 308 and outlet manifold 304 to outlet 309. In alternate arrangements, the gas can be also injected/introduced into the HTF 318 at any location along the height of the bubble column 301.

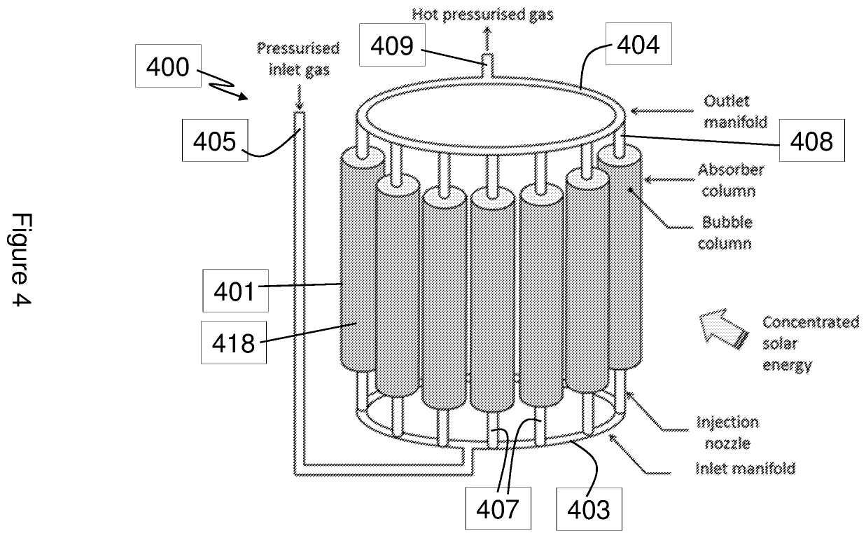

Referring now to FIG. 4 there is depicted a schematic representation 400 of a high temperature solar bubble receiver/reactor in a billboard configuration. Again, like reference numerals of FIG. 4 are utilised to identify like components of solar receiver 300 of FIG. 3.

As for the billboard configuration of FIG. 3, this system employs bubble columns 401 of a HTF 418 to heat a pressurised gas. This receiver/reactor configuration 400 is typically placed in the middle of a “surround field” of heliostats to collect radiation from all around the field. The concentrated solar radiation directed to the receiver is absorbed on the outer side of the bubble column 401 (absorber column). The absorbed heat is then transferred to the pressurised gas within the bubbling medium, which is generated by injecting the gas through injection nozzles 407 at the base of the HTF column for pressurised inlet gas received from inlet 405 via manifold 403. It is readily apparent that various alternative configurations and numbers of the bubble columns can be employed. It is also readily apparent that various alternative configurations and numbers of the gas injection nozzles can be employed. As for billboard configuration solar receiver 300 of FIG. 3, the gas is injected through the nozzles at the bottom of the molten metal/metal oxide columns and then heated as a bubbling medium by the heat that is transferred through the absorber (column) surface where heated pressurised gas exits the HTF 418 and absorber column 401 via outlet nozzle 408 and outlet manifold 404 to outlet 409. It is readily apparent that the gas can be also injected/introduced into the HTF at any location along the bubble column height.

### Indirectly Heated Solar Bubble Column Cavity Receiver

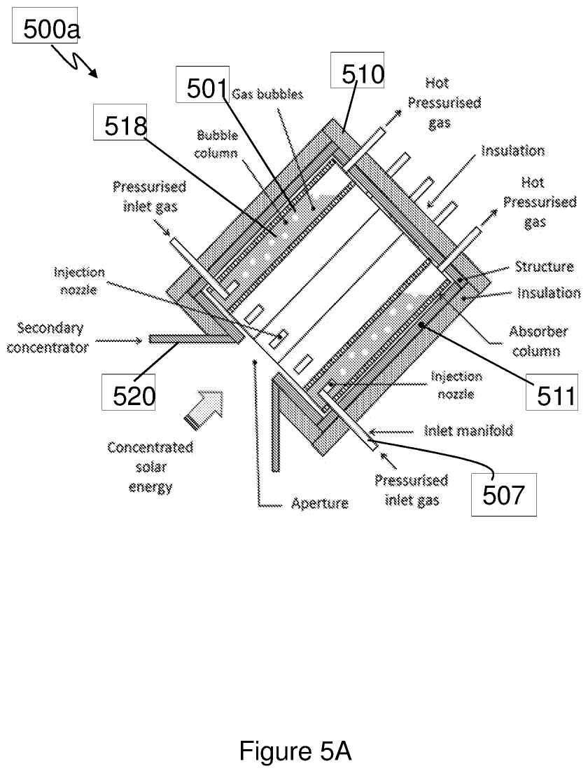

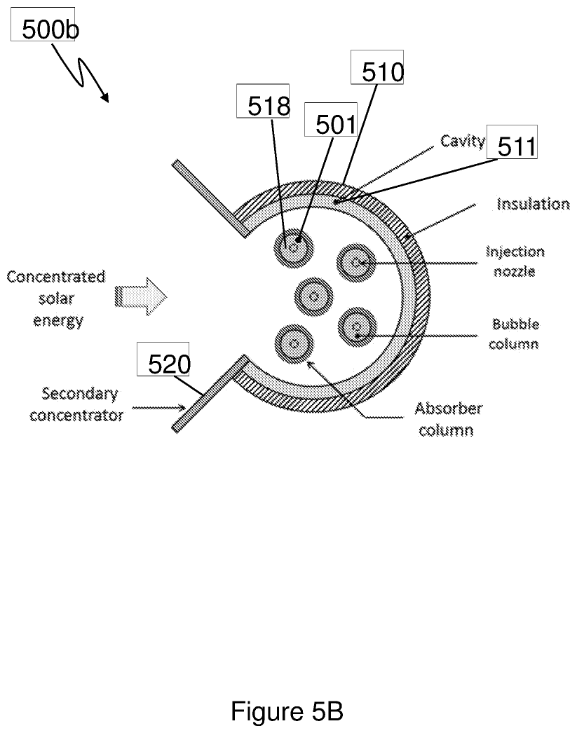

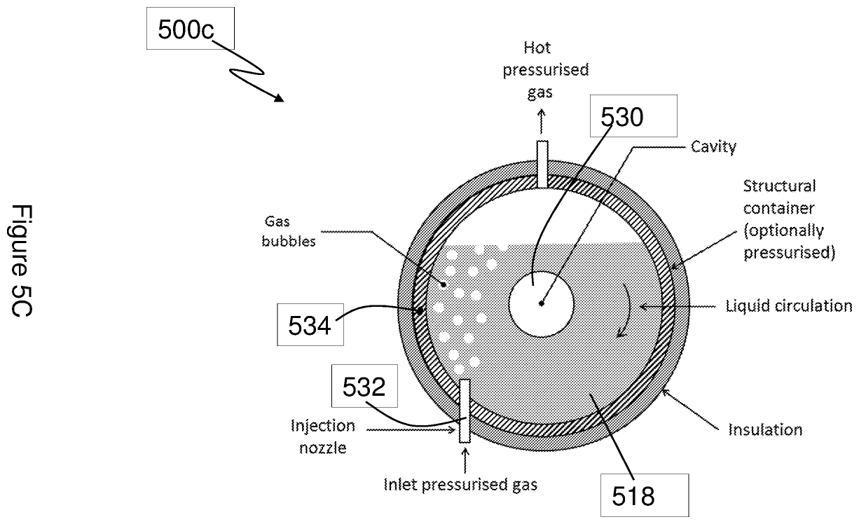

FIGS. 5A and 5B present the key components of indirectly heated solar bubble receivers/reactors 500a and 500b with a HTF 518 such as molten metal/metal oxide as depicted in solar receivers 100, 200, 300 and 400 of FIGS. 1, 2, 3 and 4 respectively. These example system arrangements employ several bubble columns 501 of a HTF 518 together with a cavity solar receiver 510. The concentrated solar radiation is directed into the solar cavity 511 and absorbed through the outer surface of the bubble columns 501. The absorbed heat is then transferred to the pressurised gas within the bubbling medium, which is generated by blowing a gas through nozzles 507 (only one of a possible plurality shown) at the bottom of the HTF column 501. The system is shown here for two configurations 500a and 500b shown respectively in FIGS. 5A and 5B. However, it can be also applied in other related orientations, configurations and numbers of bubble columns with different arrangements as would be appreciated by the skilled addressee. The gas can be also injected into the bubble column at different locations. A secondary concentrator 520 can be usefully employed at the aperture to increase the concentration ratio of the inlet solar radiation heat flux. This secondary concentrator 520 can be parabolic or other suitable profile as would be appreciated by the skilled addressee.

Indirectly Heated Solar Bubble Receiver/Reactor with a Circulating Heat Transfer Fluid

FIG. 5C presents a further possible configuration 500c of the proposed indirectly heated solar bubble receiver/reactor. Configuration 500c further comprises a circulating heat transfer fluid (HTF) 518 around the chamber 530. Indirectly heated cavity receiver 500c together with a bubble reactor/receiver as disclosed herein may advantageously be used to heat a pressurised gas steam which is bubbled through inlet nozzles 532 (only one of a possible plurality shown) configured asymmetrically relative to the chamber axis into a liquid bath. It will be appreciated to one skilled in the art that any configuration of inlet nozzles can be used, arranged so as to induce a large-scale movement of fluid around chamber, such as the use of an asymmetric injection of bubbles that injects more fluid on one side of the chamber than the other to generate an asymmetric flow of fluid in the chamber 530.

Configuration 500c consists of cavity 530, which is suspended in a HTF 518. A pressurised gas is bubbled asymmetrically through nozzles 532 into the HTF bath to induce an upward flow through HTF 518 and to generate circulation of the HTF 518 around the cavity 530. The nozzles 532 in this particular embodiment are distributed asymmetrically on one side of the cavity to generate a large-scale circulation of the heat transfer fluid around the cavity as the bubbles on that side rise to the surface. The driving force required to circulate the HTF 518 is generated both pneumatically and hydrodynamically. This provides sufficient lift to circulate the HTF 518 around the cavity 530 and also achieves good transfer of heat to the walls 534 of reactor 500c and good transport of heat and mass within the receiver/reactor 500c.

### Directly Heated Solar Bubble Receiver

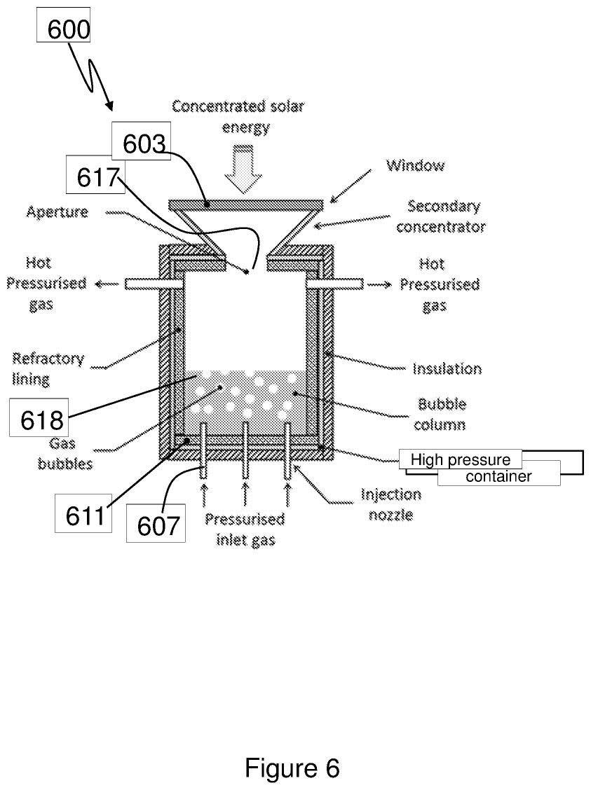

One possible configuration of a directly heated solar bubble receiver 600 is shown in FIG. 6 as a schematic representation of the directly heated solar cavity bubble receiver/reactor in the vertical orientation. This system employs a cavity solar receiver/reactor 611 together with a HTF 618 (e.g. molten metal/metal oxide) both to absorb the concentrated solar radiation and to heat a pressurised gas, which is bubbled through nozzles 607 into the HTF (column). The solar thermal energy is absorbed by the mixture of HTF 618 and bubbling gas, the latter of which is used to transfer heat to another device. This configuration can be applied to a wide range of alternative orientations, including the beam down-configuration 600 shown here in FIG. 6. A parabolic or other suitably profiled secondary concentrator can be also employed at the aperture 617 to increase the concentration ratio of the inlet solar radiation heat flux. The cavity receiver and bubble column are integrated within the insulated pressure vessel. It is readily apparent that different configurations of the solar receiver can be employed. A window 603 is also used to prevent gases leaving the system, though windowless configurations are also possible. As would be appreciated by the skilled addressee, the injected gas through the nozzles 607 at the bottom of the molten metal/metal 618 oxide column is heated as a bubbling medium within the cavity absorber.

### Reactor System

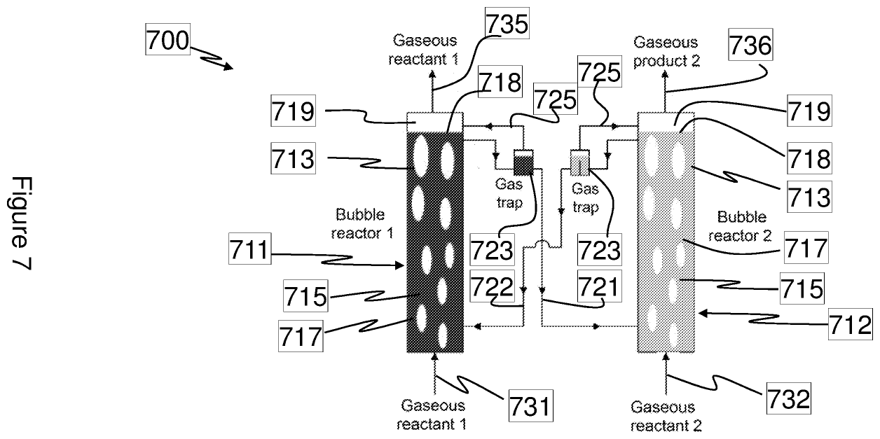

Referring to FIG. 7, there is shown an embodiment of a reactor system 700 for contacting a reactant liquid with two gaseous reactants. The two gaseous reactants are hereinafter referred to as Gaseous Reactant 1 and Gaseous Reactant 2, and are so identified in FIG. 7. The reaction between Gaseous Reactant 1 and the reactant liquid produces a gaseous product, which is hereinafter referred to as Gaseous Product 1 and is so identified in FIG. 7. Similarly, the reaction between Gaseous Reactant 2 and the reactant liquid produces a gaseous product, which is hereinafter referred to as Gaseous Product 2 and is so identified in FIG. 7.

The reactor system 700 comprising two reactors 711, 712 interconnected for circulation of a reactant liquid therebetween, whereby the circulating reactant liquid is enabled to react with the Gaseous Reactant 1 introduced into reactor 711 and to also react with Gaseous Reactant 2 introduced into the reactor 712.

Each reactor 711, 712 is configured as a bubble reactor, comprising a body 713 defining a reaction chamber 715 adapted to contain a portion of the reactant liquid as a column 717.

The portion of the reactant liquid contained as column 717 is of a volume less than the volume of the chamber 715 whereby the upper portion of the column 717 defines a surface 718, and a gas collection space 719 is provide within the chamber 715 above the surface 718. With this arrangement, gaseous fluids separating from the column 717 can accumulate in the gas collection space 719, from where they can leave the chamber 715, as is explained further below. The gas collection space 719 also allows the reactant liquid 717 to expand freely, for example, in response to gas injection, thermal expansion or the like.

Each reactor 711, 712 is configured as a gas-lift reactor, with the two gas-lift reactors so interconnected that the lift (upward flow) within each column 717 generates circulation of reactant liquid between the two reactors. Accordingly, the driving force required for circulation of reactant liquid between the two reactors 711, 712 is generated hydrodynamically.

This may be achieved by interconnecting the two reactors 711, 712 so that upward flow of reactant liquid exiting from an upper section of each reactor is introduced into a lower section of the other reactor, thereby establishing a continuous circulation of the reactant liquid between two reactors.

In the arrangement shown, the two reactors 711, 712 are interconnected for circulation of the reactant liquid therebetween via two flow paths 721, 722, with flow path 721 extending between the upper section of reactor 711 and the lower section of reactor 712, and flow path 722 extending between the upper section of reactor 712 and the lower section of reactor 711. Each flow path 721, 722 communicates with the upper section of the respective reactor 711, 712 below surface 718 of the respective column 717.

A gas trap 723 is incorporated in each flow path 721, 722 to separate entrained bubbles from the reactant liquid prior to introduction of the reactant liquid to the other reactor. This is to avoid the mixing of the different gaseous reactants. Each gas trap 723 communicates with the gas collection space 719 of the respective reactor 711, 712 via return line 725 for return of any gas removes from the circulating reactant liquid.

An inlet means 731 is provided for introducing Gaseous Reactant 1 into the reaction chamber 715 of reaction chamber 711, and an inlet means 732 is provided for introducing Gaseous Reactant 2 into the reaction chamber 715 of reactor 712. In alternate arrangements, the gas can be also injected/introduced into the liquid at any location along the bubble column reactors 711, 712.

Each inlet means 731, 732 is adapted to introduce the respective gaseous reactant under pressure into the lower section of the respective reaction chamber 715, thereby generating lift (upward flow), causing circulation of reactant liquid between the two reactors 711, 712. Each inlet means 731, 732 may comprise one or more inlets, each of which may be of any appropriate form such as a sparger or injection nozzle. In embodiments comprising two or more inlets 731, 732, the plurality of inlets to either or both reaction chambers 711, 712 may be arranged either symmetrically or asymmetrically with respect to any axis of the reaction chambers 711, 712. An asymmetric arrangement of inlet nozzles may, in particular embodiments, provide greater reaction efficiency between the gaseous reactant and the HTF 713, 715.

An outlet means 735 is provided for removing Gaseous Product 1 from the reaction chamber 715 of first reaction chamber 711. Similarly, an outlet means 736 is provided for removing Gaseous Product 2 from the reaction chamber 715 of second reaction chamber 712.

With this arrangement, the two reactors 711, 712 comprise bubble reactors, each functioning as a riser, in which the injection of the respective reactant gas induces a lift that circulates the reactant liquid between the two reactors.

With each reactor 711, 712 configured as a gas-lift reactor and with the two gas-lift reactors so interconnected that the lift (upward flow) generates circulation of reactant liquid between the two reactors, the driving force for circulation of reactant liquid between the two reactors is generated hydrodynamically, as previously explained. This is particularly advantageous for the circulation of liquids under challenging conditions such as under high operating temperatures and pressures, or in aggressive environments such as with reductive or oxidative chemicals. These conditions may be technically too challenging for the use of pumps to circulate the high temperature molten oxygen carrier between the bubble reactors.

The reactor system 700 may be used for liquid chemical looping; for example, combustion (LCLC) or for liquid chemical looping gasification (LCLG), with the reactant liquid comprising an oxygen carrier, or for molten salt chemical looping for separation of HBr in a halogen-based natural gas conversion process. By way of example, the reactant liquid may comprise a high temperature molten metal oxide functioning as a liquid oxygen carrier. As alluded to above, the hydrodynamic circulation of the liquid oxygen carrier is particularly advantageous under challenging conditions such as under high operating temperatures and pressures, or in aggressive environments such as with reductive or oxidative chemicals, as occurs with LCLC and LCLG systems. These conditions are expected to be technically too challenging for the use of pumps to circulate the high temperature molten oxygen carrier between the bubble reactors.

In use of reactor system 700 for liquid chemical looping combustion (LCLC) or for liquid chemical looping gasification (LCLG), with the reactant liquid comprising an oxygen carrier, one reactor may comprise a fuel reactor and the other reactor may comprise an air reactor. With this arrangement, one gaseous reactant comprises a gaseous fuel and the other gaseous reactant comprises air. As will be appreciated, the systems disclosed herein are not limited only to fuel and air, but rather any kind of gaseous, liquid or solid fuels such as those employed in gasification processes together with any other gases such as air, steam, CO₂ etc. can be used.

The reactor system 700 may be implemented in a power cycle involving power generation with gas turbines, although other high temperature processes and other power cycles are contemplated.

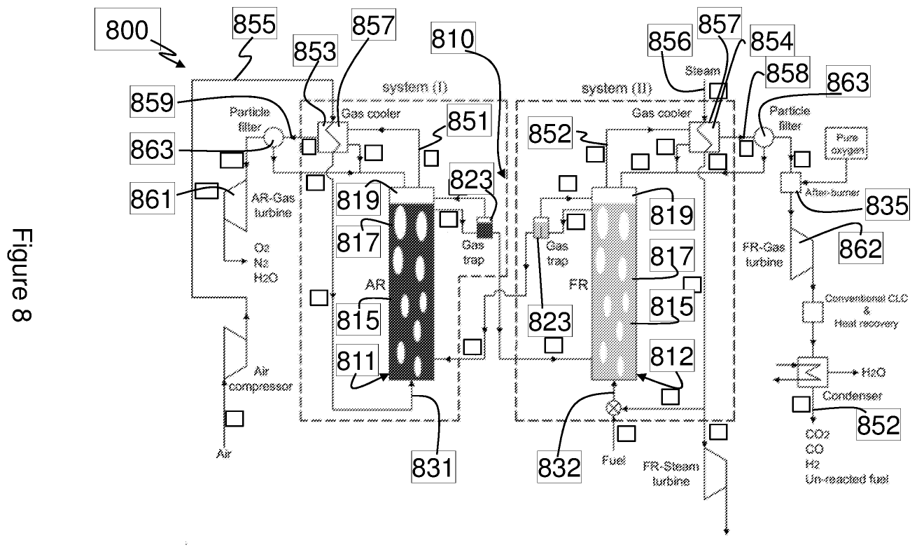

An implementation of reactor system 700 for liquid chemical looping is disclosed in the second embodiment shown in FIG. 8. Specifically, FIG. 8 illustrates one possible configuration of a LCLC system 800.

In the LCLC system 800 of this second embodiment, the fuel comprises Methane, as the primary component of the natural gas, although other hydrocarbon fuels are possible. Similarly, the liquid oxygen carrier comprises molten iron oxide, although other metal oxides and fuels are possible.

The LCLC system 800 comprises reactor 811 functioning as an air reactor, and reactor 812 functioning as a fuel reactor. With this arrangement, the liquid oxygen carrier is reduced by the fuel (CH₄+4Fe₃O₄→12FeO+CO₂+2H₂O) in fuel reactor 812, and the reduced the liquid oxygen carrier reacts with oxygen from the air (FeO(I)+2O₂→Fe₃O₄) in the air reactor 811. To avoid solidification of the slag melt, an air reactor temperature of 1650° C. and a fuel reactor temperature of 1600° C. are adopted in this embodiment, although other temperatures are possible. The reactors 811, 812 are configured to provide a high rate of heat/mass transfer and be capable of operating continuously at high temperatures and pressures. The liquid oxygen carrier from the outlet of each reactor 811, 812 is circulated to the inlet end of the other reactor. The driving force required to circulate the liquid oxygen carrier between the reactors 811, 812 is generated hydrodynamically, as explained in relation to the first embodiment. The oxidising air is injected at the base of the air reactor 811 to induce an upward flow within it while the fuel is injected together with steam at the base of the fuel reactor 812. This provides both sufficient lift to circulate the liquid oxygen carrier and also achieves good transfer of heat and mass within the fuel reactor 812. Gas traps 823 are also employed as bubble traps to separate gas bubbles from the liquid oxygen carrier streams and allow them to be removed.

The technology for controlling gas-liquid metal reactions in high temperature processes is well-developed and commercially available in related processes such as blast and bottom blown basic oxygen furnaces (BOF) and kilns. Due to the similarities between the system 800 described here and the BOF, the design of reactors 811, 812 as air-lift reactor can be based on those of the BOF, where oxygen is blown through a bed of molten pig iron. The reactors 811, 812 may be lined with basic refractory. The inlet means 831, 832 may each comprise one or more nozzles configured as tuyeres.

In the arrangement illustrated, the exit gas streams 851, 852 from reactors 811, 812 respectively are used for power generation with gas turbines 861, 862, although other high temperature processes and other power cycles could alternatively be used.

To meet the specifications for the inlet conditions to a gas-turbine, it is necessary to remove the evaporated metal/metal oxides together with any condensed phase particulate matter arising from the de-sublimation and crystallization of the vaporised metal/metal oxide components. One approach to mitigation of these emissions is through the use of gas coolers 853, 854 placed downstream from each reactor 811, 812 respectively. The inlet air stream 855 for the gas cooler 853 connected to air reactor 811 and the water steam 856 for the gas cooler 854 connected to fuel reactor 812 are each pre-heated in heat exchangers 857, which also lowers the temperature of the exit gas streams 851, 852 to below the minimum temperature of melting/condensation of the metal/metal oxides. This temperature is 1377° C. for FeO so that an outlet temperature of approximately 1350° C. is used for the gas coolers, while an outlet temperature of 600° C. is chosen for the heated steam from the gas cooler for the fuel reactor. This means that an outlet temperature of 1350° C. can be achieved for the hot gas streams (identified as streams 858, 859 in FIG. 8), which enables efficient power generation. A configuration of a shell and tube heat exchanger is proposed for the gas coolers. In the arrangement illustrated, the cooling fluid (air or water steam, as streams 855, 856 in FIG. 8) is transmitted through the tubes while the high temperature gas from the reactors (exit gas streams 851, 852) is transmitted through the shell. Other configurations or cooling systems are also possible. It is worth noting that this design enables the temperature of the tubes of the gas coolers 853 and 854 to be maintained at below 1000° C., which is suitable for commercially available steel tubes, which offer both high rates of heat transfer and sufficient strength for pressurisation. The outer shell of the gas coolers can be lined either with refractory bricks or other high temperature coating materials (e.g. ceramics). This enables low heat loss from the gas coolers, due to the low thermal conductivity of the refractory bricks and ceramics.

The gas coolers 853, 854 have potential to generate fine particles via de-sublimation of the vaporised metal/metal oxide components. Since particles of approximately 10 μm can cause erosion of turbine blades, the use of particles filters 863 is also used. Sufficient efficiency of particle removal can be achieved through high efficiency cyclones, which can be designed to efficiently remove particles of diameter greater than 0.5 μm with a low pressure drop. These types of cyclones are commercially available and used in pressurised fluidised bed combustion combined cycles and integrated gasification combined cycles. It is worth noting that further purification of the gas streams is also possible through application of electrostatic precipitators and hot gas filters.

Equilibrium calculations show that the mole fraction of any unreacted fuel in stream 852 is negligible, while the mole fractions of H₂ and CO are 0.0056 and 0.0059, respectively. This corresponds to an extent of fuel conversion of approximately 97.0% and an extent of fuel conversion based on heating value of approximately 98.10%. In other words, approximately 98% of the total inlet energy to the system can be employed for power generation at a temperature of 1350° C., while the rest leaves the system through stream 852 as a mixture of H₂ and CO diluted with CO₂, where the mole fractions of CO and H₂ are approximately 0.006, after removal of the water via the condenser. It is worth noting that this loss of exergy, through un-reacted CO and H₂ can be recovered. One option is to inject oxygen into an after-burner 835 positioned prior to the gas turbine 862 connected to the fuel reactor 812, as shown in FIG. 8. Another option would be to use a conventional CLC system, that is, interconnected fluidised CLC and rotary fixed bed CLC systems. Still further options are also possible as would be appreciated by the skilled addressee. The calculations also predict that the mole fractions of gaseous Fe and FeO in stream 858 and stream 859 from gas coolers 853 and 854 are less than 10-7.

System 800 seeks to overcome the limitations of prior art CLC with both solid and liquid oxygen carriers, as discussed previously. In particular, system 800 seeks to achieve:
(a) Elimination of the technical complications associated with the use of solid OCs, including both particles and fixed beds, through application of a molten metal oxide as an oxygen carrier.
(b) Potential to achieve a high outlet temperature of the hot gas of up to 1350° C., which is suitable for high thermal efficiency power plant such as gas turbines, either in open or combined cycles.
(c) Elimination of the limitations of the need for semi-batch reactors as was proposed in US 2011/0117004. These require valves to switch the fuel and air streams between the reactors and also do not achieve steady state operation. In contrast, the use of two interconnected bubble reactors does achieve continuous and steady-state operation through the lift generated by the gas streams to circulate the liquid oxygen carrier.
(d) Elimination of the need for heating coils within the pool of molten metal oxide, through direct introduction of fuel and air into the molten bed and the application of the hot product gases for power generation, after being treated through gas coolers to separate the evolved gas from and the molten metal oxides.
(e) The potential to achieve a high fuel conversion efficiency of more than 98.0%.
(f) The potential to achieve continuous output for either dispatchable power generation or continuous high temperature chemical processing.
(g) Good compatibility between the reactors and other commercially available technologies, such as bottom blown basic oxygen furnaces (BOF) and kilns.
(h) A reactor configuration that is suitable for robust operation at high pressure, through the use of a refractory-lined steel shell. This is because the process eliminates the need to transfer heat through the pressurise vessel.

Chemical looping gasification is similar to CLC except that a sub-stoichiometric ratio of oxygen is supplied to the fuel by the oxygen carrier, which in turn results in the production of syngas (i.e. CO and H₂). The main advantage of CLG over conventional gasification systems is that the syngas product is not diluted by N₂ from the air. As for the CLC systems, the CLG systems in the state-of-the-art are mainly based on interconnected fluidised bed reactors, where a solid fuel is gasified with steam within the fuel reactor to produce syngas and a reduced oxygen carrier. The reduced oxygen carrier is then separated from the ash and sent to the air reactor, where the reduced oxygen carrier particles are oxidised with oxygen from air.

The configuration of the proposed liquid chemical looping gasification (LCLG) is relatively similar to that of the LCLC system. However, in the proposed LCLG system a lower circulation flow rate of the liquid oxygen carrier is employed between the fuel and air reactors than that required to achieve a stoichiometric ratio. Furthermore, an ash separator is proposed between the fuel and reactor to separate molten ash from the LOC.

The following limitations have been identified in the CLG processes, which the proposed LCLG system seeks to overcome:
(a) The life of solid oxygen carrier particles is limited by the chemical/physical damage that occurs in consecutive Red-Ox reactions due to thermal shock, agglomeration, erosion and changes to the crystalline structure etc. The situation is worse for case of solid fuels that produce residual ash after gasification, since with the ash has direct contact with the oxygen carrier particles. This can contaminate the particles, which reduces their reactivity by inhibiting mass transfer.
(b) The separation of ash and solid oxygen carrier particles is technically challenging.
(c) The breakage of the oxygen carrier particles further inhibits their separation from the ash.

The proposed system seeks to overcome the above limitations of CLG with solid oxygen carriers through:
Elimination of the technical challenges described previously associated with the use of solid oxygen carriers through the use of a liquid oxygen carrier.
Elimination of the technical challenges associated with the separation of ash and solid oxygen carriers by use of a molten metal oxide. The density of ash and molten metal oxides is different, so that they can be readily separated in a separator drum.

It is worth noting that the LCLC and LCLG can be also hybridised with solar thermal energy.

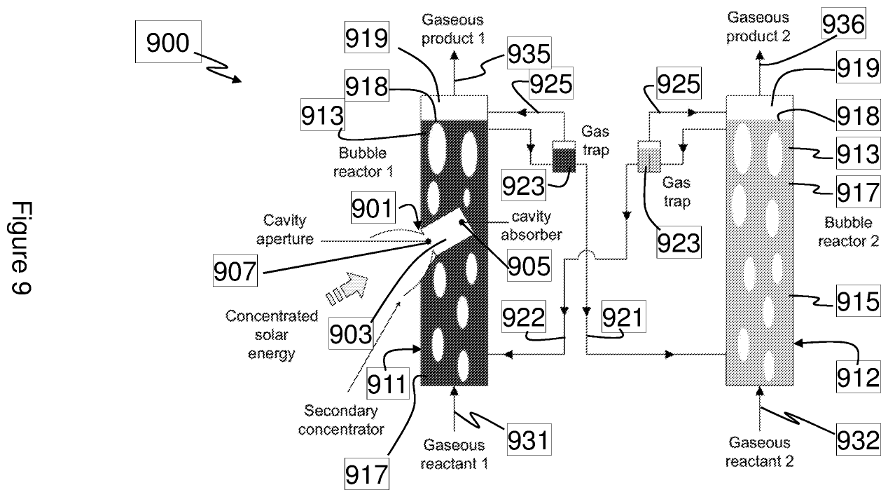

Referring to FIG. 9, there is shown an embodiment of a reactor system 900 for contacting a reactant liquid with two gaseous reactants, in which a heat source 901 is employed to heat the circulating liquid between the reactors 911, 912. In the arrangement shown, the heat source 901 is associated with reactor 911. Other arrangements are possible. In other embodiments, for example, the heat source may be associated with reactor 912, or there may be respective heat sources associated with both reactors 911, 912. In yet another embodiment, the heat source may be associated with the path along with the circulating liquid flows between the reactors 911, 912.

The reactor system 900 is similar in many respects to the reactor system 800 described and illustrated in FIG. 8. Accordingly, similar reference numerals are used to denote similar parts.

In the arrangement shown, the heat source 901 comprises a solar receiver 903 operable to absorb concentrated solar radiation to input concentrated solar thermal energy to reactor 911. The solar receiver 903 comprises a solar cavity receiver having a cavity 905 in which concentrated solar thermal energy is absorbed from concentrated solar radiation entering through cavity aperture 907. The absorbed heat within the cavity 905 is then used to heat the liquid circulating between the reactors 911, 912.

The heat source 901 need not be restricted to solar thermal energy, and any other appropriate form of heat source could be used as would be understood by a person skilled in the art.

Directly Heated Solar Receiver Reactor with Circulating Heat Transfer Fluid

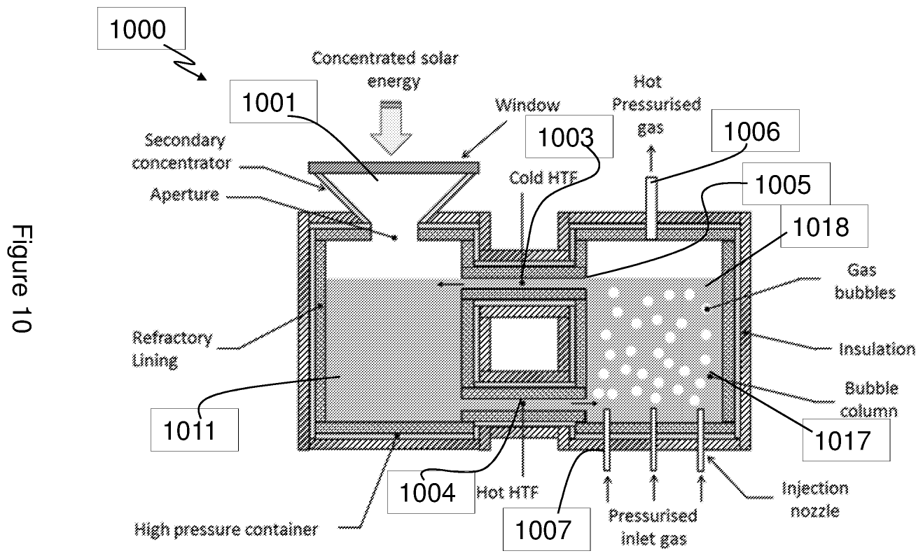

FIG. 10 presents one possible configuration 1000 of an example directly heated solar receiver with a circulating HTF. The directly heated solar receiver/reactor 1000 with circulating heat transfer fluid includes a directly heated cavity receiver together with a bubble reactor/receiver and is used to heat a pressurised gas steam. The system 1000 consists of a cavity solar receiver 1001, in which a HTF 1003 is exposed to concentrated solar radiation and a bubble column 1017. A pressurised gas is bubbled through the nozzles 1007 into the HTF column 1017. The cold HTF 1003 from the outlet end 1005 of the bubble column 1017 is circulated to the solar cavity absorber 1011, while the existing heated HTF 1004 from bottom of the cavity receiver 1011 is introduced to the bottom of the bubble column 1018. The driving force required to circulate the HTF 1018 between the reactors is generated both pneumatically and hydrodynamically. The pressurised inlet gas is injected through nozzles 1007 at the base of the bubble column 1017 to induce an upward flow through it. This provides sufficient lift to circulate the heat transfer fluid 1018 and also achieves good transfer of heat to the walls and good transport of heat and mass within the reactor. A bubble trap can be also employed at the outlet 1006 from the bubble column 1017 to separate the gas bubbles from the HTF stream and allow the liquid to be returned to the column 1017, although this is not shown in FIG. 10.

It is readily apparent that a range of alternative configurations of this solar receiver can be employed to achieve the same effect. It is also readily apparent that in all above configurations a range of alternative combinations of metal/metal oxides, reactant and non-reactant gases and configurations of the solar receivers can be employed.

The proposed directly heated solar receiver/reactor with circulating heat transfer fluid. A directly heated cavity receiver together with a bubble reactor/receiver according to the embodiments described herein may be used to heat a pressurised gas steam.

It is readily apparent that in all above configurations a range of alternative combinations of metal/metal oxides, reactant and non-reactant gases and configurations of the solar receivers can be employed.

### EMBODIMENTS

Reference throughout this specification to “one embodiment”, “an embodiment”, “one arrangement” or “an arrangement” means that a particular feature, structure or characteristic described in connection with the embodiment/arrangement is included in at least one embodiment/arrangement of the present invention. Thus, appearances of the phrases “in one embodiment/arrangement” or “in an embodiment/arrangement” in various places throughout this specification are not necessarily all referring to the same embodiment/arrangement, but may. Furthermore, the particular features, structures or characteristics may be combined in any suitable manner, as would be apparent to one of ordinary skill in the art from this disclosure, in one or more embodiments/arrangements.

Similarly, it should be appreciated that in the above description of example embodiments/arrangements of the invention, various features of the invention are sometimes grouped together in a single embodiment/arrangement, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment/arrangement. Thus, the claims following the Detailed Description are hereby expressly incorporated into this Detailed Description, with each claim standing on its own as a separate embodiment/arrangement of this invention.

Furthermore, while some embodiments/arrangements described herein include some but not other features included in other embodiments/arrangements, combinations of features of different embodiments/arrangements are meant to be within the scope of the invention, and form different embodiments/arrangements, as would be understood by those in the art. For example, in the following claims, any of the claimed embodiments/arrangements can be used in any combination.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

### Different Instances of Objects

As used herein, unless otherwise specified the use of the ordinal adjectives “first”, “second”, “third”, etc. to describe a common object, merely indicate that different instances of like objects are being referred to, and are not intended to imply that the objects so described must be in a given sequence, either temporally, spatially, in ranking, or in any other manner.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: “including” or “which includes” or “that includes” as used herein is also an open term that also means “including at least” the elements/features that follow the term, but not excluding others. Thus, including is synonymous with and means comprising.

### Scope of Invention

Thus, while there has been described what are believed to be the preferred arrangements of the invention, those skilled in the art will recognize that other and further modifications may be made thereto without departing from the spirit of the invention, and it is intended to claim all such changes and modifications as fall within the scope of the invention. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It will be appreciated that the methods and systems described above at least substantially provide apparatus operable using concentrated solar radiation including a reactor system for contacting a reactant liquid with gaseous reactant(s).

The receiver/reactor systems and methods described herein, and/or shown in the drawings, are presented by way of example only and are not limiting as to the scope of the invention. Unless otherwise specifically stated, individual aspects and components of the receiver/reactor systems and methods described herein may be modified, or may have been substituted therefore known equivalents, or as yet unknown substitutes such as may be developed in the future or such as may be found to be acceptable substitutes in the future. The systems and methods described herein may also be modified for a variety of applications while remaining within the scope and spirit of the claimed invention, since the range of potential applications is great, and since it is intended that the present receiver/reactor systems and methods be adaptable to many such variations.

1. Apparatus operable using concentrated solar radiation, the apparatus comprising:
a body having a cavity adapted to receive concentrated solar radiation;
a heat energy absorber associated with the cavity to receive heat from concentrated solar radiation within the cavity;
a chamber containing a body of matter, the chamber being in heat exchange relation with the heat energy absorber to receive heat therefrom for heating the body of matter; and
an inlet means for introducing fluid into the chamber for contacting the contained body of matter.

2. Apparatus operable using concentrated solar radiation, the apparatus comprising:
a body having a cavity adapted to receive concentrated solar radiation;
a heat energy absorber associated with the cavity to receive heat from concentrated solar radiation within the cavity;
a chamber containing a body of matter, the chamber being in heat exchange relation with the heat energy absorber to receive heat therefrom for heating the body of matter;
an inlet means for introducing fluid into the contained body of matter, with fluid separating from the body of matter as a gaseous fluid; and
an outlet means for removing the separated gaseous fluid from the chamber.

3. Apparatus for treating a fluid using concentrated solar radiation, the apparatus comprising:
a body having a cavity adapted to receive concentrated solar radiation;
a heat energy absorber associated with the cavity to receive heat from concentrated solar radiation within the cavity;
a chamber containing a body of matter, the chamber being in heat exchange relation with the heat energy absorber to receive heat therefrom for heating the body of matter;
an inlet means for introducing fluid to be treated into the contained body of matter, with fluid separating from the body of matter as a treated gaseous fluid; and
an outlet means for removing the separated gaseous fluid from the chamber.

4. Apparatus according to any one of claims 1 to 3, comprising a plurality of chambers, each said chamber comprising a body of matter adapted for receiving heat from said heat energy absorber.

5. Apparatus according to any one of claims 1 to 3, wherein said treated gas comprises heated gas.

6. Apparatus according to any one of claims 1 to 3, wherein said body of matter comprises a heat transfer liquid.

7. Apparatus according to claim 6, wherein said heat transfer liquid comprises metal/metal oxides such as Ga, Sb, Pb, Sn, Fe, Cu, Cr, Ti, CuO and AgO.

8. Apparatus according to claim 6, wherein said heat transfer liquid comprises a non-metallic fluid.

9. Apparatus according to claim 8, wherein the non-metallic fluid comprises a molten salt.

10. A solar receiver for treating a gas, the solar receiver comprising:
a body having a cavity adapted to receive concentrated solar radiation;
a heat energy absorber associated with the cavity to receive heat from concentrated solar radiation within the cavity;
a chamber containing a body of matter, the chamber being in heat exchange relation with the heat energy absorber to receive heat therefrom for heating the body of matter;
an inlet means for introducing gas into the contained body of matter for heat exchange therewith; and
an outlet means for removing treated gas separated from the body of matter.

11. A solar receiver for heating a gas, the solar receiver comprising:
a body having a cavity adapted to receive concentrated solar radiation;
a heat energy absorber associated with the cavity to receive heat from concentrated solar radiation within the cavity;
a chamber containing a body of heat transfer liquid, the chamber being in heat exchange relation with the heat energy absorber to receive heat therefrom for heating the heat transfer liquid;
an inlet means for introducing gas into the body of heat transfer liquid for heat exchange therewith; and
an outlet means for removing heated gas separated from the heat transfer liquid.

12. A solar receiver according to either claim 10 or claim 11, comprising a plurality of chambers, each said chamber comprising a body of matter adapted for receiving heat from said heat energy absorber.

13. A solar receiver according to any one of claims 10 to 12, wherein said treated gas comprises heated gas.

14. A solar receiver according to any one of claims 10 to 12, wherein said body of matter comprises a heat transfer liquid.

15. A solar receiver according to claim 14, wherein said heat transfer liquid comprises metal/metal oxides such as Ga, Sb, Pb, Sn, Fe, Cu, Cr, Ti, CuO and AgO.

16. A solar receiver according to claim 14, wherein said heat transfer liquid comprises a non-metallic fluids with the appropriate thermo-physical properties.

17. Apparatus according to claim 16, wherein the non-metallic fluid comprises a molten salt.

18. A method of treating a fluid, the method comprising use of apparatus according to any one of claims 1 to 3.

19. A method of treating a gas, the method comprising use of a solar receiver according to either claim 10 or claim 11.

20. A method of heating a gas, the method comprising use of a solar receiver according to either claim 10 or claim 11.

21. A method of heating a fluid, the method comprising:
heating a body of heat transfer liquid;
introducing fluid to be heated into the heated body of heat transfer liquid;
separating the fluid from the body of heat transfer liquid as a heated gaseous fluid; and
collecting the separated gaseous fluid.

22. A method of heating a gas, the method comprising:
receiving concentrated solar radiation;
heating a body of heat transfer liquid using thermal energy derived from the concentrated solar radiation;
introducing gas to be heated into the heated body of heat transfer liquid;
separating the gas from the body of heat transfer liquid; and
collecting the separated gas.

23. A method of performing a process using a first fluid and second fluid, the method comprising:
receiving concentrated solar radiation;
applying thermal energy derived from the concentrated solar radiation to the first fluid; and
introducing the second fluid into the first fluid.

24. A reactor system for contacting a reactant liquid with two gaseous reactants, the reactor system comprising two reactors interconnected for circulation of a reactant liquid therebetween, whereby the circulating reactant liquid is enabled to react with a gaseous reactant introduced into one reactor and to also react with a gaseous reactant introduced into the other reactor.

25. A method of contacting a reactant liquid with two gaseous reactants, the method comprising use of apparatus according to claim 24.

26. A method of contacting a reactant liquid with two gaseous reactants, the method comprising circulating the reactant liquid between two reactors, introducing one gaseous reactant into one reactor and introducing the other gaseous reactant into the other reactor, whereby the circulating reactant liquid is enabled to react with gaseous reactant introduced into one reactor and to also react with gaseous reactant introduced into the other reactor.

27. A method of performing liquid chemical looping combustion (LCLC) or for liquid chemical looping gasification (LCLG), wherein the method comprises use of apparatus according to the first aspect of the invention and wherein with the reactant liquid comprises an oxygen carrier.

28. A method of provided a method of performing liquid chemical looping combustion (LCLC) or for liquid chemical looping gasification (LCLG), the method comprising circulating a reactant liquid comprising an oxygen carrier between a fuel reactor and an air reactor, introducing a gaseous fuel into the fuel reactor and introducing air into the air reactor, whereby the circulating reactant liquid is enabled to react with fuel introduced into the air reactor and to also react with air introduced into the air reactor.
